(19) United States
(12) Patent Application Publication
(10) Pub. No.: US 2026/0017614 A1
(43) Pub. Date: Jan. 15, 2026

(54) Management system and management method of garden tool

(71) Applicant: Greenworks (Jiangsu) Co., Ltd., Changzhou (CN)

(72) Inventors: Yun YANG, Changzhou (CN); Wenxuan JIANG, Changzhou (CN); Anlong ZHONG, Changzhou (CN)

(73) Assignee: Greenworks (Jiangsu) Co., Ltd., Changzhou (CN)

(21) Appl. No.: 19/332,030

(22) Filed: Sep. 17, 2025

Related U.S. Application Data
(63) Continuation of application No. PCT/CN2024/083337, filed on Mar. 22, 2024.

(30) Foreign Application Priority Data
Mar. 30, 2023 (CN) 202310332691.4
May 10, 2023 (CN) 202310523798.7
May 10, 2023 (CN) 202310528110.4
Sep. 6, 2023 (CN) 202311147882.X
Sep. 7, 2023 (CN) 202311152351.X
Sep. 7, 2023 (CN) 202311154915.3
Sep. 7, 2023 (CN) 202311158225.5

(51) Int. Cl. G06Q 10/10; G06Q 10/0631; G06Q 10/1091; G06Q 50/02; H04L 67/12; H04W 4/021

(52) U.S. Cl. CPC G06Q 10/103; G06Q 10/063114; G06Q 10/1091; G06Q 50/02; H04L 67/12; H04W 4/021

(57) ABSTRACT

A management system includes a cloud server, at least one garden tool, and at least one intelligent terminal. The at least one garden tool is provided with a communication module, and working information of the garden tool is uploaded to the cloud server through the communication module. The at least one intelligent terminal is communicatively connected with the garden tool to receive the working information of the garden tool and is communicatively connected with the cloud server. The intelligent terminal obtains work records of an operator through inputting operator information. The garden tool uploads the working information to the cloud server according to a communication protocol or uploads the work records and the operator information to the cloud server through the intelligent terminal.

### CROSS REFERENCE TO RELATED APPLICATION

The present application is a continuation Application of PCT application No. PCT/CN2024/083337 filed on Mar. 22, 2024, which claims the benefit of CN202311158225.5 filed on Sep. 7, 2023, CN202311147882.X filed on Sep. 6, 2023, CN202311152351.X filed on Sep. 7, 2023, CN202311154915.3 filed on Sep. 7, 2023, CN202310528110.4 filed on May 10, 2023, CN202310523798.7 filed on May 10, 2023, and CN202310332691.4 filed on Mar. 30, 2023. All the above are hereby incorporated by reference for all purposes.

### TECHNICAL FIELD

The disclosure relates to a management system and management method of a garden tool, which belongs to a field of garden technology.

### BACKGROUND

Garden tool refers to mechanical equipment used for greening, construction, and maintenance of gardens. When a garden needs to be greened, constructed, maintained, etc., various types of garden tools are often needed. Since there may be multiple types of garden tools, the number of each type of garden tools may also be multiple. It is inconvenient for the work group to manage different garden tools when completing their working tasks. Therefore, there is room for improvement.

### SUMMARY

The disclosure provides a management system and a management method of a garden tool, which can manage different garden tools.

One or more embodiments of the disclosure provide a management system of the garden tool. The management system includes a cloud server, at least one garden tool and at least one intelligent terminal.

The at least one garden tool is provided with a communication module, and working information of the at least one garden tool is uploaded to the cloud server through the communication module.

The at least one intelligent terminal is communicatively connected with the garden tool garden tool to receive the working information of the at least one garden tool, and communicatively connected with the cloud server to obtain work records of an operator through inputting operator information of the operator.

Wherein, the at least one garden tool is configured to upload the working information to the cloud server or upload the work records and the operator information to the cloud server through the at least one intelligent terminal according to a communication protocol.

In an embodiment of the disclosure, the at least one garden tool is configured to upload the working information to the cloud server through a direct line according to the communication protocol, and the at least one garden tool is configured to upload the work records and the operator information to the cloud server through the at least one intelligent terminal through an indirect line according to the communication protocol.

In an embodiment of the disclosure, when a communication performance of the direct line is stronger than a communication performance of the indirect line, an executed action of the management system is to upload the working information through the at least one garden tool, and when the communication performance of the direct line is weaker than the communication performance of the indirect line, the executed action is to upload the work records through the at least one intelligent terminal and simultaneously upload the operator information.

In an embodiment of the disclosure, a comparison of the communication performance of the communication protocol comprises one or more of bit error rate, signal-to-noise ratio, bandwidth, data rate, delay and throughput.

In an embodiment of the disclosure, when the direct line and the indirect line are obstructed, the executed action is that the at least one garden tool or the at least one intelligent terminal caches the working information until one of the direct line and the indirect line is unobstructed.

In an embodiment of the disclosure, the management system further includes a trailer, a gateway is provided on the trailer, the gateway is configured to communicate with the at least one garden tool, the at least one intelligent terminal and the cloud server respectively to upload the working information and the operator information through the gateway.

In an embodiment of the disclosure, the communication module of the at least one garden tool is one or more of 4G, 5G, Wifi, Lora, Zigbee, Bluetooth, and a Bluetooth module, and the Bluetooth module is a Bluetooth device or a Bluetooth battery pack.

In an embodiment of the disclosure, the at least one intelligent terminal is paired with the Bluetooth device through at least one of scanning a QR code located on the Bluetooth device, contacting an NPC, or inputting a PIN code.

In an embodiment of the disclosure, the Bluetooth battery pack is configured to supply power to the at least one garden tool, and the Bluetooth battery pack is configured to obtain the working information of the at least one garden tool and transmit the working information to the at least one intelligent terminal through Bluetooth.

In an embodiment of the disclosure, the at least one intelligent terminal is provided with an intelligent terminal positioning module to obtain positioning information of the at least one intelligent terminal, the at least one intelligent terminal is further provided with a user interaction interface, the user interaction interface is configured to receive and execute user instructions and display the working information of the at least one garden tool, and the at least one intelligent terminal is configure to obtain corresponding working tasks according to the user instructions and pair with the corresponding garden tool according to the working tasks.

In an embodiment of the disclosure, the at least one intelligent terminal is configured to at least display the operator's physical health status, information of bound garden tool, current working hours and historical work records, and when the at least one intelligent terminal determines that the operator's physical health status is not within preset conditions, the executed action is that the at least one intelligent terminal obtains the operator's positioning information to send an alarm message to the cloud server, and send the alarm message to other intelligent terminals based on the positioning information.

In an embodiment of the disclosure, the at least one garden tool is provided with a garden tool positioning module to position the at least one garden tool, the management system further comprises at least one management terminal, and the are least one management terminal is used to obtain information of the at least one garden tool and draw a geographic fence based on a position of a trailer and/or a working area.

In an embodiment of the disclosure, the at least one management terminal is configured to preset the working area and an abnormal working area based on the geographic fence, when the at least one management terminal determines that a position of the at least one garden tool is within the working area, the executed action is that the at least one management terminal issues a normal prompt, and when the at least one management terminal determines that the position of the at least one garden tool is within the abnormal working area, the executed action is that the at least one management terminal issues a warning prompt or an alarm prompt.

In an embodiment of the disclosure, the at least one management terminal is configured to preset a warning area and an alarm area based on the abnormal working area, when the at least one management terminal determines that the position of the at least one garden tool is within the warning area, the executed action is that the at least one management terminal issues the warning prompt, and when the at least one management terminal determines that the position of the at least one garden tool is within the alarm area, the executed action is that the at least one management terminal issues the alarm prompt.

In an embodiment of the disclosure, the executed action when the at least one management terminal determines that a garden tool taken out from a warehouse and a garden tool stored back to the warehouse are different, the executed action is that the at least one management terminal issues a locking instruction to a lost garden tool to lock the lost garden tool.

In an embodiment of the disclosure, the at least one management terminal is configured to preset a corresponding recommended working time period of each of different accessories of different garden tools, obtain an usage time period of each of the accessories, calculate a corresponding cumulative usage time period based on the usage time period of each of the accessories, and perform different operations based on a comparison result of the cumulative usage time period and the corresponding recommended working time period of each of the accessories.

In an embodiment of the disclosure, the at least management terminal is configured to preset a normal working time period based on the recommended working time period of each of the accessories, when the at least one management terminal determines that the corresponding cumulative usage time period of one of the accessories is less than or equal to the normal working time period, the executed action is that the at least one management terminal issues a normal working instruction to the one of the accessories, and when the at least one management terminal determines that the corresponding cumulative usage time period of the one of the accessories is greater than the corresponding normal working time period, the executed action is that the at least one management terminal issues a warning working instruction or an alarm working instruction to the one of the accessories.

In an embodiment of the disclosure, the at least one management terminal is further configured to preset a warning working time period based on the recommended working time period of each of the accessories, when the at least one management terminal determines that the cumulative usage time period of the one of the accessories is greater than the corresponding normal working time period and less than the corresponding warning working time, the executed action is that the at least one management terminal issues the warning working instruction to the one of the accessories, and when the at least one management terminal determines that the cumulative usage time period of the one of the accessories is greater than the warning working time period, the executed action is that the at least one management terminal issues the alarm working instruction to the one of the accessories and displays specific information of the corresponding one of accessories on the at least one management terminal.

In an embodiment of the disclosure, when the at least management terminal determines that there is a corresponding spare part, the executed action is that the at least one management terminal issues a replacement success instruction, resets the corresponding cumulative usage time, and save a corresponding historical record, and when the at least one management terminal determines that there is no corresponding spare part, the executed action is that the at least one management terminal issues a replacement failure instruction and recommend corresponding spare parts on a sales market.

One or more embodiments of the disclosure further provide a management method of the garden tool, and management method includes operations as follows.

The garden tool and an intelligent terminal are communicatively connected with the cloud server, and the intelligent terminal obtains the work records of an operator through inputting operator information.

The intelligent terminal is communicatively connected with the corresponding garden tool.

A communication line is set between the garden tool and the cloud server as a direct line, and a communication line is set between the intelligent terminal and the cloud server as an indirect line.

The working information is uploaded to the cloud server through the direct line or the work records and the operator information are uploaded to the cloud server through the indirect line.

One or more embodiments of the disclosure further provide a management method of the garden tool, and the management method includes following operations.

The garden tool, an intelligent terminal and a management terminal are communicatively connected with the cloud server respectively, and the intelligent terminal obtains the work records of the operator through the inputting operator information of the operator.

The intelligent terminal is communicatively connected with the corresponding garden tool.

The communication line is set between the garden tool and the cloud server as a direct line, and the communication line is set between the intelligent terminal and the cloud server as an indirect line.

in response to upload instruction from the management terminal, the cloud server obtaining the working information through the direct line or obtaining the work records and the operator information through the indirect line.

In an embodiment of the disclosure, the management method further includes operations as follows.

A position of the garden tool is obtained.

A geographic fence is drawn based on a position of a trailer and/or a working area.

Different operations are executed based on a comparison result of the geographic fence and the position of the garden tool.

In an embodiment of the disclosure, the management method further includes operations as follows.

A usage time period of different accessories of different garden tools is obtained.

A corresponding recommended working time period of the one of the different accessories is preset.

A corresponding cumulative usage time period is calculating based on the usage time period of the one of the accessories.

Different operations are executed based on a comparison result of the cumulative usage time period of the one of the different accessories and the corresponding recommended working time period.

In summary, the disclosure provides the management system and management method of the garden tool, which can monitor various types of garden tools in real time to obtain corresponding positions, the working information, etc. when a work group needs to be dispatched to complete work. The operator may also select an appropriate communication line to upload data through the intelligent terminal. The intelligent terminals may not only serve as a data transfer station, but also as an auxiliary tool for the operator to improve work efficiency. At the same time, the operator's physical health status may also be monitored in real time through the intelligent terminal to ensure operator's safety.

Of course, any product implementing the disclosure does not necessarily need to achieve all of advantages described above at the same time.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic view of a management system of a garden tool according to at least one embodiment of the disclosure.

FIG. 2 is a schematic view of a communication connection of a management system.

FIG. 3 is a schematic view of a management interface of a management system.

FIG. 4 is a schematic view of a personnel search interface in a management system.

FIG. 5 is a schematic view of a personnel detailed information interface in a management system.

FIG. 6 is a schematic view of a device statistics interface in a management system.

FIG. 7 is a schematic view of a device search interface in a management system.

FIG. 8 is a schematic view of a device detailed information interface in a management system.

FIG. 9 is a schematic view of a work assignment interface in a management system.

FIG. 10 is a schematic view of a work group interface in a management system.

FIG. 11 is a schematic view of a path selection interface in a management system.

FIG. 12 is a schematic view of a geographic fence display interface of a management system.

FIG. 13 is a schematic view of a working information display interface in a management system.

FIG. 14 is a schematic view of an intelligent terminal working interface in a management system.

FIG. 15 is a schematic view of a personnel history record interface in a management system.

FIG. 16 is a schematic view of a working task generation interface in a management system.

FIG. 17 is a schematic view of a management system managing a mower system.

FIG. 18 is a structural block view of a mower.

FIG. 19 is a first functional module view of a mower system.

FIG. 20 is a schematic view of a working area of a lawn.

FIGS. 21A, 21B, 21C and 21D are UI (user interface) schematic views of an intelligent terminal according to a working situation of a mower in a working area.

FIG. 22 is a second functional module view of a mower system.

FIGS. 23A and 23B are UI schematic views of an intelligent terminal according to a mower in a continuous working mode.

FIGS. 24A and 24B are UI schematic views of an intelligent terminal according to working conditions of a mower in a pause working mode.

FIG. 25 is a schematic view of a mower moving along a guide wire at a certain distance.

FIG. 26 is a schematic view of a random mowing operation of a mower after the mower reaches a target work starting point.

FIG. 27 is a schematic view of a positioning of a mower by a management system.

FIG. 28 is a schematic view of RTK (Real-Time Kinematic) differential positioning method.

FIG. 29 is a schematic flowchart of a positioning of a mower by a management system.

FIG. 30 is an interface view of an application program of an intelligent terminal for selecting a tool type that is the same as a mower type.

FIG. 31 is an interface view for searching for a mower to be paired using a Bluetooth module of an intelligent terminal.

FIG. 32 is an interface conversion view of scanning an identification code of a mower using an intelligent terminal.

FIG. 33 is an interface conversion view of inputting a PIN code into an application program of an intelligent terminal.

FIG. 34 is an interface conversion view from a mower restarting interface to a mower naming interface.

FIG. 35 is an interface conversion view from an indicating pairing success interface to a mower setting interface.

FIG. 36 is an interface conversion view of multiple interfaces for pairing a mower, an RTK base station and an intelligent terminal.

FIG. 37 is an interface conversion view for establishing a working area boundary map.

FIG. 38 is an interface conversion view for setting a no go zone in a working area boundary map.

FIG. 39 is an interface conversion view for setting a position of a charging station in a working area boundary map after setting a no go zone.

FIG. 40 is an interface conversion view during a moving operation of a mower.

FIG. 41 is a schematic view of an after-sales service system in a management system.

FIG. 42 is a schematic view of a garden tool in an after-sales service system.

FIG. 43 is a visualization view of an after-sales view of a product of a garden tool.

FIG. 44 is a UI page display view of a component of an electrical work.

FIG. 45 is a flowchart showing a management method of a garden tool

FIG. 46 is a UI display view of a component in an operation of a garden tool.

FIG. 47 is a flowchart of a management system for after-sales management of a garden tool.

FIG. 48 is a flowchart of a management system for managing accessories of a garden tool.

FIG. 49 is a flowchart of S250 in FIG. 48.

FIG. 50 is a flowchart of a management system managing a working situation of a garden tool.

FIG. 51 is a flowchart of S340 in FIG. 50.

FIG. 52 is another flowchart of a management system managing a working situation of a garden tool.

### PART NUMBER DESCRIPTION

100—management system, 110—garden tool, 111—sensing unit, 112—information collection unit, 113—control unit, 114—storage unit, 120—communication module, 130—intelligent terminal, 140—management terminal, 150—cloud server, 160—client terminal;
210—trailer;
310—personnel search interface, 311—personnel search button, 312—personnel brief information button, 313—new personnel button, 320—personnel detailed information interface;
410—device search interface, 411—device search button, 412—device brief information button, 413—new device button, 420—device detailed information interface;
510—work assignment interface, 511—group brief information button, 512—new group button, 520—work group interface;
610—path selection interface, 611—path information display block, 612—path information map;
710—geographic fence display interface, 720—geographic fence setting button, 730—geographic fence;
810—working information display interface, 820—report search button, 830—report brief information button, 840—task complete state button;
900—device statistics interface, 910—intelligent terminal working interface, 920—personnel history record interface, 930—working task generation interface;
1000—Mower, 1010—walking assembly, 1020—operating assembly, 1030—power supply assembly, 1040—path planning module, 1050—control module, 1060—storage module, 1070—positioning module, 1100—boundary wire, 1200—charging station, 1300—outfield loop, 1400—sensor, 1500—guide wire, 1600—infield loop, 1700—RTK base station.

### DETAILED DESCRIPTION

Technical solutions in the embodiments of the disclosure will be clearly and completely described below in conjunction with the drawings in the embodiments of the disclosure. Obviously, the described embodiments are only part of the embodiments of the disclosure, rather than all the embodiments. Based on the embodiments in this disclosure, all other embodiments obtained by ordinary technicians in this field without making any creative work shall fall within a scope of protection of this disclosure.

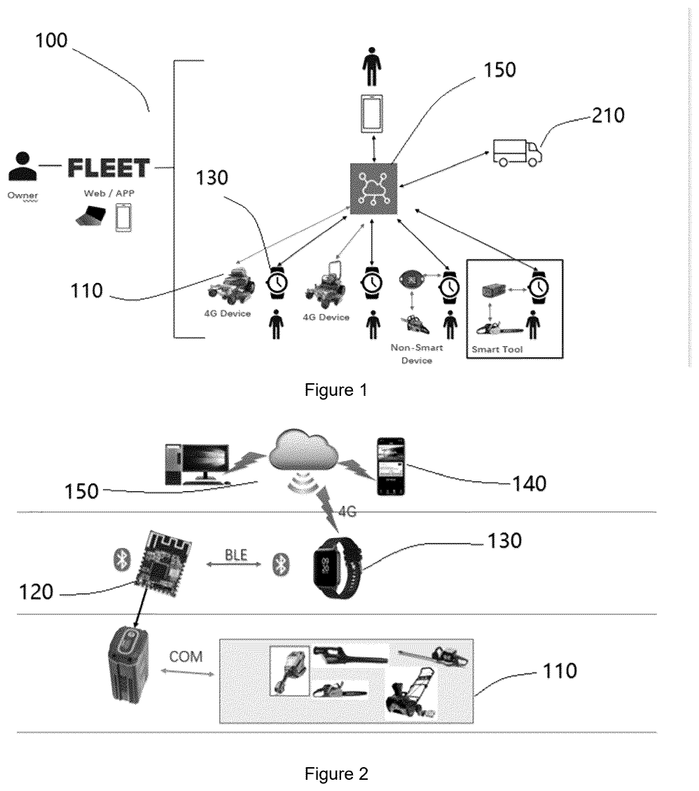

FIG. 1 and FIG. 2 shows a management system of a garden tool. The management system 100 may be used to manage a garden tool 110, such as mowers, snow blowers, handheld electric saws, edge trimmers, hedge trimmers, string trimmers, lawn combers, lawn mowers, and the like.

In an embodiment, the management system 100 may include the garden tool 110, a communication module 120, an intelligent terminal 130, a management terminal 140, a cloud server 150 and a trailer 210.

In an embodiment, the communication module 120 is detachably installed on the garden tool 110. The garden tool 110 may communicate with the intelligent terminal 130 through the communication module 120. Working information of the garden tool 110 may be uploaded to the cloud server 150 through the communication module 120.

In an embodiment, the intelligent terminal 130 may be paired and connected with the garden tool 110. The intelligent terminal 130 may be communicated with the cloud server 150. The intelligent terminal 130 may upload the working information of the garden tool 110 to the cloud server 150.

In an embodiment, the management terminal 140 may be communicated with the cloud server 150, and the management terminal 140 may obtain information on the intelligent terminal 130 through the cloud server 150.

Please refer to FIG. 2. Each garden tool 110 may be installed with the communication module 120. The communication module 120 of the garden tool may be one or more of 4G, 5G, Wifi, Lora, Zigbee, Bluetooth, and Bluetooth modules. The Bluetooth module may be a Bluetooth device or a Bluetooth battery pack.

In an embodiment, when pairing the intelligent terminal 130 with the communication module 120, the intelligent terminal 130 may be paired with a Bluetooth device of the garden tool 110 by at least one of scanning a QR code, contacting an NPC, or entering a PIN code.

Please refer to FIG. 2. The communication module 120 may be a Bluetooth device. The Bluetooth device is detachably installed on the garden tool 110. The Bluetooth device may be communicated with the intelligent terminal 130 through Bluetooth communication and obtain the working information of the garden tool 110.

Please refer to FIG. 2. The communication module 120 may also be a Bluetooth battery pack. The Bluetooth battery pack is detachably installed on the garden tool 110. The Bluetooth battery pack may be communicated with the intelligent terminal 130 through Bluetooth communication and obtain the working information of the garden tool 110. At the same time, the Bluetooth battery pack may supply power for the garden tool 110.

Please refer to FIG. 2. When the working information of the garden tool 110 is obtained through the intelligent terminal 130, the working information may include but is not limited to a purchase date, a usage time period, a usage times, a last usage time, a last maintenance time, a next maintenance time, a battery state and a current working state. The current working state may include current working hours, planned working hours, operation power, motor rotating speed, device health state, etc.

Please refer to FIG. 2. The intelligent terminal 130 may be a smart watch. Since the smart watch is worn on an operator's arm, operator information may be recorded into the smart watch, so that the intelligent terminal 130 may correspond to the operator. The intelligent terminal 130 may obtain an operator's work record by inputting operator information.

In an embodiment, the intelligent terminal 130 may be connected with a gateway of a trailer 210 through a communication protocol. The communication protocol may be Wifi, Bluetooth, low-power Bluetooth, cellular network, GMS, etc. The intelligent terminal 130 may also be communicated with the cloud server 150 through GSM card.

In an embodiment, the intelligent terminal 130 may be provided with an intelligent terminal positioning module. The intelligent terminal positioning module may receive global positioning satellite (GPS) signals from satellites to obtain current positioning information. At the same time, the intelligent terminal 130 may upload the current positioning information of the garden tool 110 to the cloud server 150 in real time. After the operator matches the intelligent terminal 130 with the garden tool 110, the positioning information at this time may represent current positionings of the operator, the intelligent terminal 130 and the garden tool 110.

Please refer to FIG. 2. The garden tool 110 may upload the working information to the cloud server 150 according to the communication protocol. Wherein, a communication line through which the garden tool 110 uploads the working information to the cloud server 150 according to the communication protocol is a direct line.

In an embodiment, in a process of uploading data through the direct line, the working information may include the work records and the operator information. The work record may represent a historical work record of the garden tool 110. The historical work record may include a historical usage time period, a usage times and corresponding operator information, a time point of each usage, a time period of each usage, a location of each usage, etc. of the garden tool 110. The operator information may include name, photo, mobile phone number, email address, title, etc.

Please refer to FIG. 2. The garden tool 110 may also upload the work records and the operator information to the cloud server 150 through the intelligent terminal 130. Wherein, the communication line through which the garden tool 110 uploads the work records and the operator information to the cloud server 150 through the intelligent terminal 130 according to the communication protocol is an indirect line.

In an embodiment, in a process of uploading data through the indirect line, the work record may include the working information. The working information may include the purchase date, the usage time period, the usage times, the last usage time, the last maintenance time, the next maintenance time, the battery state and the current working state. The current working state may include current working hours, planned working hours, etc.

Please refer to FIG. 2. For different communication lines, communication performances are different. When it is necessary to upload the working information of the garden tool 110, the communication line may be selected from the direct line or the indirect line for uploading. Wherein, the garden tool 110 needs to detect whether the direct line and the indirect line are unobstructed.

In one embodiment, when both communication lines are unavailable, the working information, the work records, etc. will be cached in the garden tool 110 or the intelligent terminal 130 until one of the communication lines is unobstructed, and then the working information or the work records will be uploaded to the cloud server 150.

In one embodiment, when one communication line is unobstructed and the other communication line is obstructed, it may be considered that the communication performance of the unobstructed communication line is stronger than the communication performance of the obstructed communication line, and the working information or the work records may be uploaded to the cloud server 150 through the unobstructed communication line.

In one embodiment, when both communication lines are unobstructed, it is necessary to select one communication line with better communication performance to upload the working information at this time.

Please refer to FIG. 2. A performance of a communication line may be represented by parameters such as bit error rate, signal-to-noise ratio, bandwidth, data rate, delay, and throughput. For example, when parameters such as the bit error rate, signal-to-noise ratio, bandwidth, data rate, delay, and throughput of one communication line are all stronger than those of the other communication line, it may be said that the communication performance of this communication line is stronger than that of the other communication line.

In one embodiment, when both the direct line and the indirect line are unobstructed, a performance of the direct line may be compared with a communication performance of the indirect line to obtain the communication line with the best communication performance to upload information.

In one embodiment, when the communication performance of the direct line is stronger, the working information may be directly uploaded to the cloud server 150 through the garden tool 110. At the same time, it is necessary to detect whether the garden tool 110 is in a communication connection with the intelligent terminal 130. If the garden tool 110 is in the communication connection with the intelligent terminal 130, the operator information of the intelligent terminal 130 is obtained while uploading the working information, and the operator information is uploaded synchronously through the garden tool 110. If the garden tool 110 is not in the communication with the intelligent terminal 130, the operator information will not be uploaded.

In one embodiment, when a performance of the indirect line is stronger, the work record may be uploaded to the cloud server 150 through the intelligent terminal 130, and the operator information may be uploaded synchronously.

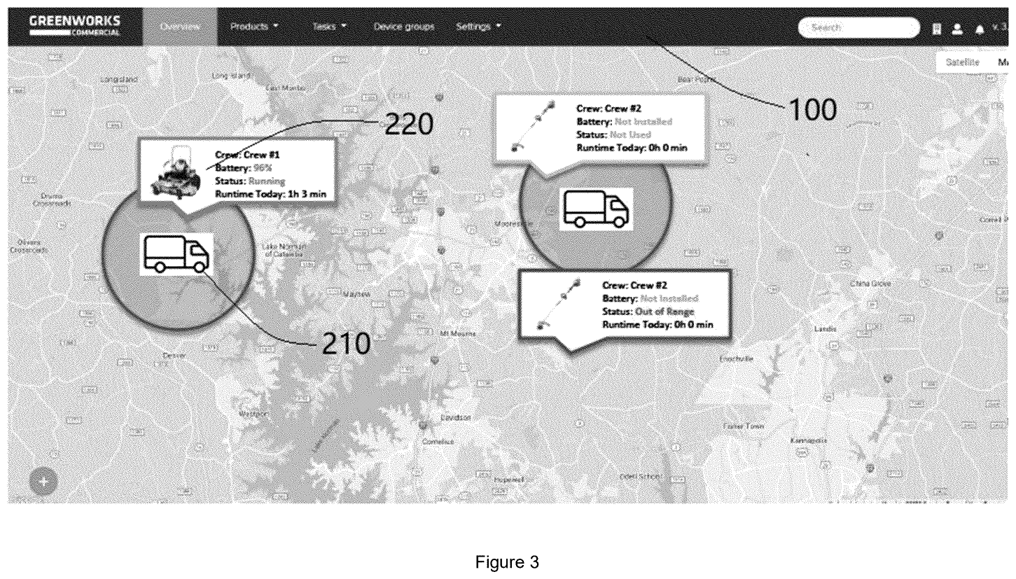

Please refer to FIG. 3. The management terminal 140 may be applied to electronic devices such as smart phones, pads, and computers. The management terminal 140 may be an application program or “app” that is downloaded or otherwise installed on a memory in an electronic device and executed by a processor of the electronic device.

In one embodiment, the management terminal 140 may be provided with a user interaction interface, capable of receiving and executing user instructions, and obtaining a current position of the garden tool 110 through the cloud server 150 for display.

In one embodiment, the management terminal 140 can provide a graphical user interface (GUI) to the operator through an electronic device. Real-time positions of the operator, the garden tool 110 and the trailer 210 may be displayed on the graphical user interface. The management terminal 140 may obtain a working state and a battery state of the garden tool 110 through the cloud server 150 for display.

In one embodiment, the management terminal 140 may be provided with a screen, and the management terminal 140 can obtain information stored in the cloud server 150 and display it on the management terminal 140.

Please refer to FIG. 3. The management terminal 140 may send an upload instruction to the cloud server 150. After receiving the upload instruction, the cloud server 150 may obtain the working information uploaded by the garden tool 110 through the communication protocol or the work records and the operator information uploaded by the intelligent terminal 130.

In one embodiment, the cloud server 150 may compare the communication performance of the direct line with the communication performance of the indirect line to obtain the communication line with the best communication performance. For example, when the communication performance of the direct line is stronger, the working information may be directly uploaded to the cloud server 150 through the garden tool 110. When the performance of the indirect line is stronger, the work record may be uploaded to the cloud server 150 through the intelligent terminal 130, and the operator information may be uploaded synchronously.

In an embodiment, a working state of the garden tool 110 may include a normal working state, a warning working state, an alarm working state, etc. The battery state of the gardening device 110 may include a number of battery charges, a remaining battery power, a battery health, a battery duration life, etc.

In an embodiment, since there may be multiple operators and multiple garden tools 110, brief information about the operators and the garden tools 110 may be displayed on the graphical user interface of the management terminal 140. The operator clicks an icon button of a corresponding operator or garden tool 110 on the graphical user interface of the management terminal 140 to obtain detailed information of the operator or the garden tool 110 through the cloud server 150 and display it.

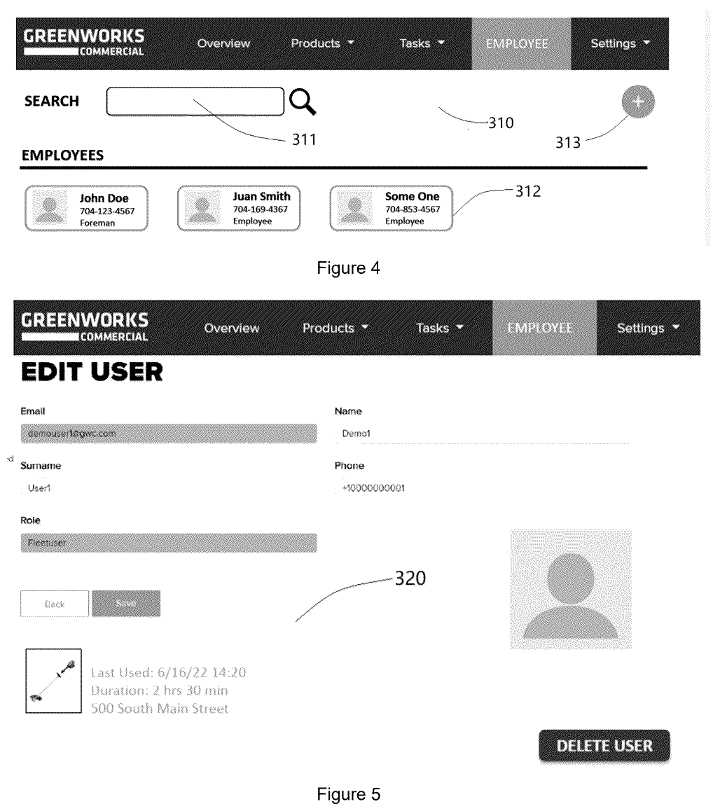

FIG. 4 illustrates the brief information of an operator displayed in the management terminal 140. A personnel search interface 310 of the graphical user interface of the management terminal 140 may display a personnel search button 311, a personnel brief information button 312, and a new personnel button 313.

In an embodiment, the operator may click the personnel search button 311 and input personnel information to be searched, so as to obtain a corresponding operator through the cloud server 150 and display it on the personnel search interface 310.

In one embodiment, the personnel brief information button 312 may include the operator's name, number, title, etc. Of course, since there will be personnel turnover in an enterprise, in order to facilitate a management of operators, information of new employees may also be entered through the management terminal 140.

In one embodiment, the new employee information may be entered through clicking the new personnel button 313 on the graphical user interface of the management terminal 140. The new personnel button 313 may be displayed as a “+” and create a new user to represent a corresponding new employee. The new employee's information may then be uploaded to the cloud server 150 for storage.

FIG. 5 illustrates detailed information of an operator displayed in the management terminal 140. When the personnel brief information button 312 of the corresponding operator is clicked in the personnel search interface 310, it may jump to the personnel detailed information interface 320.

In one embodiment, the personnel detailed information interface 320 may include name, email address, phone number, employee photo, employee number, title, salary, usage of the garden tool 110, and the like. Wherein, a usage state of the garden tool 110 may be represented by what type of garden tool 110 an employee habitually uses, a time and a place of a last use of a certain type of garden tool 110, and the like.

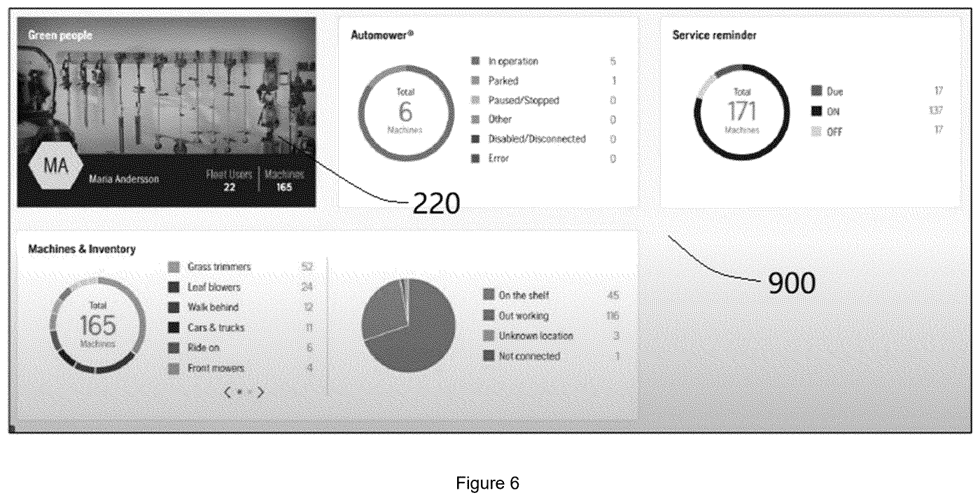

FIG. 6 shows a device statistics interface 900 in the management terminal 140. There are many types of garden tool 110. There may be multiple garden tools 110 of the same type. The management terminal 140 may obtain information of all garden tools 110 through the cloud server 150 and classify the information so as to display the information on the graphical user interface of the management terminal 140. The garden tools 110 may be displayed in a form of a chart on the management terminal 140.

In one embodiment, the garden tool 110 is described as a mower, a snow blower, a handheld electric saw, etc. When it is necessary to distinguish the types of garden tool 110, the number of the mowers, the snow blowers, and the handheld electric saws may be displayed in a chart form on the graphical user interface of the management terminal 140.

In one embodiment, the chart may be a pie chart, a line chart, a bar chart, or the like. The chart may be customized through the management terminal 140, for example, different garden tools 110 may be displayed in different colors.

In one embodiment, when it is necessary to distinguish according to the working state of the garden tool 110, the number of mowers, snow blowers and handheld electric saws in different working states may be displayed on the chart respectively, and displayed through the pie charts, the line charts and the bar charts.

In one embodiment, when a certain garden tool 110 needs maintenance service or other services, it may also be displayed on the management terminal 140 to remind the operator to repair it in time.

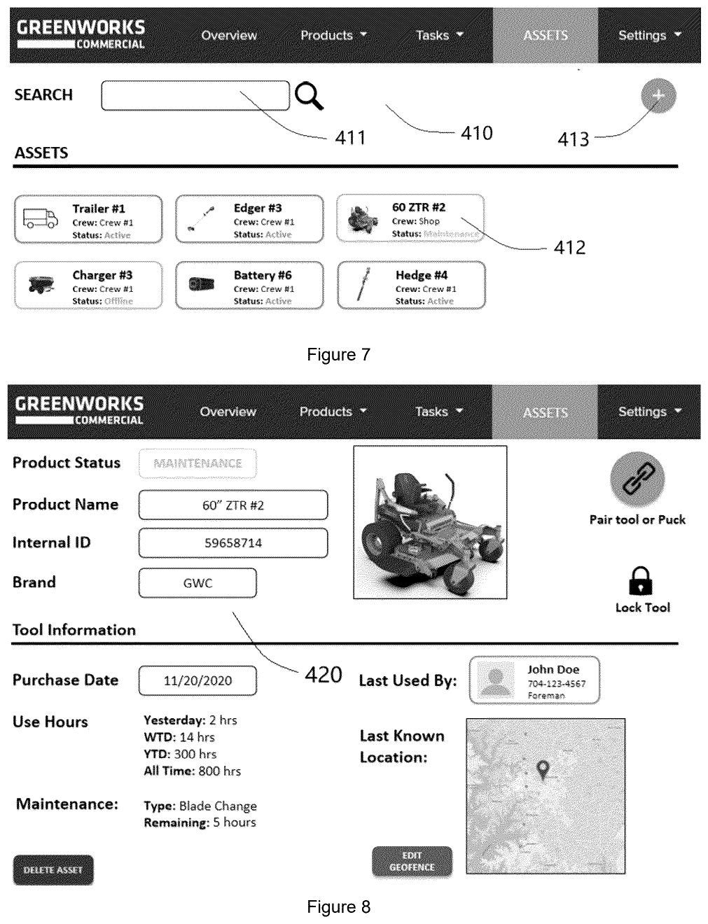

FIG. 7 shows brief information of the garden tool 110 saved in the management terminal 140. A device search interface 410 of the graphical user interface of the management terminal 140 may display a device search button 411, a device brief information button 412, and a new device button 413.

In an embodiment, the operator may click the device search button 411 and input device information to be searched, so as to obtain a corresponding garden tool through the cloud server 150 and display it on the device search interface 410.

In one embodiment, the device brief information button 412 may include a photo, type, management number, name, working state, etc. of the device. Of course, since the enterprise will add new garden tool 110, in order to facilitate a management of the newly added garden tool 110, corresponding information of the newly added garden tool 110 may also be entered through the management terminal 140.

In one embodiment, the new garden tool 110 may be entered through clicking the new device button 413 on the graphical user interface of the management terminal 140. The new device button 413 may also be displayed as a “+” and create an icon of the new garden tool 110 to represent the corresponding newly added gardening device 110. Information of the new garden tool 110 may then be uploaded to the cloud server 150 for storage.

FIG. 8 shows detailed information of the garden tool 110 displayed in the management terminal 140. When the device brief information button 412 of the corresponding garden tool 110 is clicked in the device search interface 410, it may jump to a device detailed information interface 420.

In an embodiment, the device detailed information interface 420 may include device category, device name, device photo, device management number, device brand, device state, purchase date, locked/unlocked tools, displayed information, information of a last operator, position information, historical usage time, next maintenance due time, connected or paired devices, connected or paired intelligent terminal 130, and other information. The historical usage time may be represented by the historical usage times of the garden tool 110 and a time consumed for each use.

In an embodiment, a device state may represent a state of the garden tool 110. The state may include a valid state, a maintenance state and an offline state. The valid state may indicate that the garden tool 110 may be used normally. The maintenance state may indicate that the garden tool 110 needs to be repaired due to a fault or a component that needs to be replaced. The offline state may indicate that the current garden tool 110 is unable to communicate with the management terminal 140 through the cloud server 150 due to a network failure or a failure of the communication module 120 thereon, which causes the garden tool 110 to be offline and in need of maintenance.

In one embodiment, the number of the management terminal 140 may be one or more. The management terminal 140 may be further divided into an owner terminal, an administrator terminal, and an employee terminal. Management permissions on the owner terminal, administrator terminal, and employee terminal may be different.

In one embodiment, the owner terminal may manage the administrator terminal and the employee terminal. The owner terminal can manage all information in the management terminal and can implement all functions of the management terminal 140.

In one embodiment, the administrator terminal may manage the employee terminal. The administrator terminal can view operators and assign them to work, view the working information and the position of the garden tool 110, view the battery state of the garden tool 110, view a position of the trailer 210 of a work group, and perform a maintenance on the garden tool 110.

In one embodiment, the employee terminal can receive work content assigned from the owner terminal and the administrator terminal.

In one embodiment, the number of the owner terminal may be one or more. The number of the administrator terminal may be one or more. The number of the employee terminal may be one or more. When a work group is established, there may be multiple operators in the work group. One of the operators may be set as a manager and to be bound to the administrator terminal, and remaining operators may be bound to the employee terminal. Work is completed through a cooperation between the administrator terminal and multiple employee terminals.

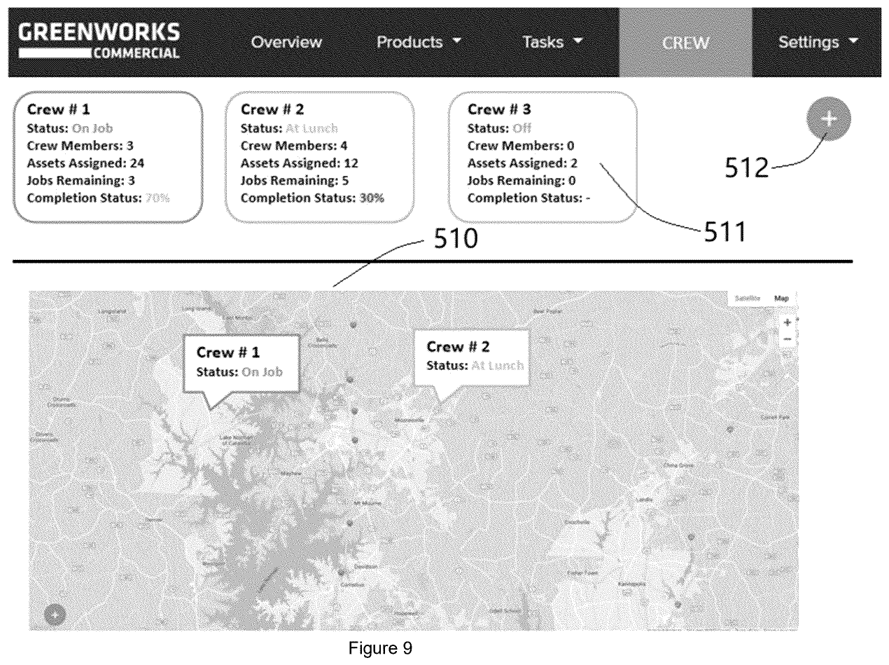

FIG. 9 illustrates brief information of a work assignment interface 510 displayed in the management terminal 140. The work assignment interface 510 may display a group brief information button 511 and a new group button 512. The management terminal 140 selects the garden tool 110 and the operator according to a working task.

In one embodiment, the group brief information button 511 may display a work group number, the working state, a personnel situation, the number of assigned garden tools 110, remaining task amount, task completion state, etc. The group brief information button 511 on the work assignment interface 510 may be clicked and corresponding operators may be created, edited, or deleted according to the working tasks. The operators are then bound to the corresponding garden tool 110 to form a corresponding work group.

In one embodiment, by clicking the new group button 512, a new work group may be added according to the working task, and corresponding operators may be created, edited, or deleted in the new work group to bind the operators to the corresponding garden tool 110. Wherein, the new group button 512 may be displayed as a “+”.

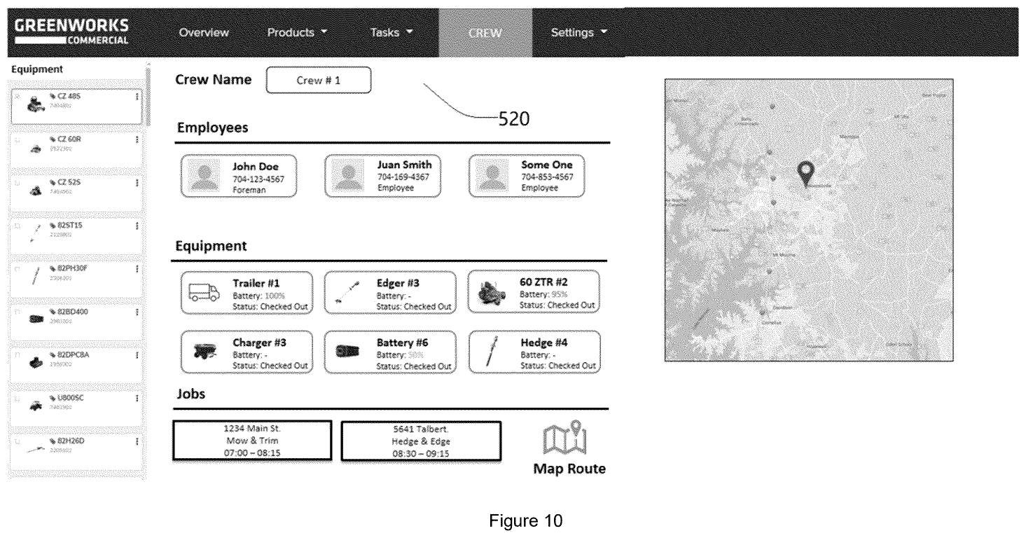

FIG. 10 illustrates detailed information of a work group interface 520 displayed in the management terminal 140. When the corresponding group brief information button 511 is clicked on the work assignment interface 510, it may jump to the work group interface 520.

In one embodiment, the work group interface 520 may include a group number, a group member display block, a garden tool display block, and a work content display block.

In one embodiment, there may be a plurality of the group member display blocks. Each operator may correspond to one group member display block. An operator's name, number, current state, etc. may be displayed in the group member display block.

In one embodiment, there may be a plurality of the garden tool display blocks. Each garden tool 110 may correspond to one garden tool display block. The garden tool display block may display the name, number, remaining power and current state of the garden tool.

In one embodiment, there may be a plurality of the work content display blocks. A task number, task content and working time may be displayed in the work content display block.

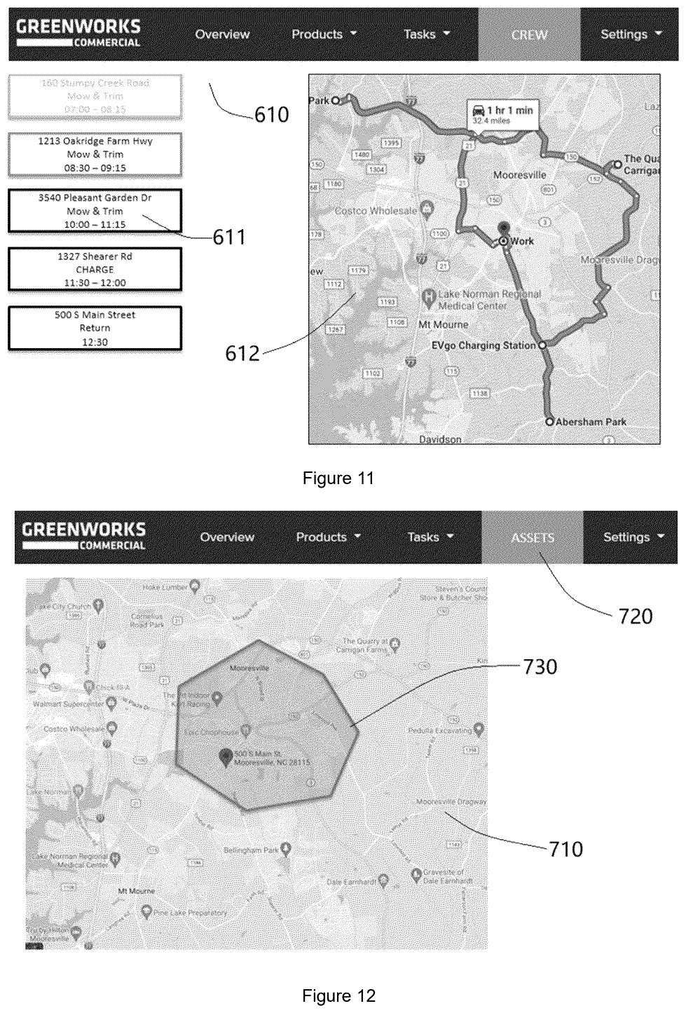

FIG. 11 illustrates detailed information of a path selection interface 610 displayed in the management terminal 140. After the work group is formed, the operator may select a corresponding transportation path through the path selection interface 610 of the management terminal 140 according to the working task to transport the trailer 210 from a warehouse to a work site. The path selection interface 610 may include a path information display block 611 and a path information map 612.

In one embodiment, since there may be multiple paths between the warehouse and the work site, there may be a plurality of the path information display blocks 611. The path information display block 611 may include a name of a passed path, a passed path distance, a passed path type, a number of passed traffic lights, a consumed time, etc. The path information map 612 may display corresponding information of different paths.

In one embodiment, after the work group is established, it is necessary to unlock the corresponding garden tool 110 and take the garden tool 110 out of the warehouse and place it on the trailer 210. The trailer 210 transports the work group and the garden tool 110 to the work site for work based on a selected transportation path.

In one embodiment, after completing work for a day, the trailer 210 will transport the work group and the garden tool 110 back to the warehouse based on another selected transportation path, and lock the corresponding garden tool 110. At the same time, it is verified whether the garden tool 110 is lost and whether the garden tool 110 needs to be repaired. In order to manage the garden tool 110 during working hours, it is necessary to draw a corresponding geographic fence 730 on a geographic fence display interface 710 through the management terminal 140.

FIG. 12 illustrates detailed information of the geographic fence of the geographic fence display interface 710. The operator jumps to the geographic fence display interface 710 by operating a geographic fence setting button 720 through operating the management terminal 140. The operator may use a pan and zoom controls to focus a map on a specific area, centered on a position of the trailer 210 and/or centered on a position of the working area, and draw a geographic fence 730 by first operating a drawing tool to draw a boundary.

In one embodiment, the working area may be an area where an operator needs to work. The boundaries created by the operator using the drawing tool may be customized for the work sites that are regularly shaped, irregularly shaped, scattered along streets, etc. When the boundary is completed, a corresponding geographic fence 730 may be drawn on the map.

In one embodiment, the geographic fence 730 may be associated with the management numbers of all the garden tools 110 required for operation, and uploaded to the cloud server 150 through the management terminal 140. The management terminal 140 may perform different operations, such as issuing a warning prompt or an alarm prompt, based on a comparison result between the position of the garden tool 110 and the geographic fence 730.

In one embodiment, the management terminal 140 may manage an applied garden tool 110 based on the geographic fence 730. The geographic fence 730 may be further arranged into a plurality of different areas. The management terminal 140 may display different states of the garden tool 110 based on comparison results of the position of the garden tool 110 with the different areas and comparison results of a time the garden tool 110 is located in the different areas with corresponding time ranges. Wherein, the time range may include a warning time range and an alarm time range. The different areas may include a working area and an abnormal working area. The abnormal working areas may include warning areas and alarm areas.

In one embodiment, the garden tool 110 is described as a mower etc. When the mower appears in the warning area during the working time and triggers a warning state, at this time the mower will emit a corresponding warning prompt sound. At the same time, the management terminal 140 will also display the corresponding warning prompt.

In an embodiment, when the mower appears in the alarm area during the working time and triggers an alarm state, at this time the mower will emit a corresponding alarm prompt sound. The mower will be turned off or enter a limp state at this time, which means that a cutter will stop running, and a walking function of the mower may be limited to low speed walking or stop walking. At the same time, the management terminal 140 will also display the corresponding alarm prompt.

In one embodiment, the alarm state is also triggered when the mower is outside the warehouse during non-working hours.

In one embodiment, the management terminal 140 may display the warning prompt or the alarm prompt through a pop-up window, a push notification, an obvious mark on a dashboard, etc. The operator may remotely lock the mower and cut off a power to the mower through operating the management terminal 140.

In one embodiment, since types and quantities of the garden tools 110 in the work group may be multiple, the garden tools 110 need to be transported back to the warehouse for storage after the day work is completed. At this time, the management terminal 140 may further perform different operations based on a comparison result between the garden tool 110 taken out from the warehouse and the garden tool 110 returned to the warehouse.

In one embodiment, when the management terminal 140 determines that a garden tool 110 taken out from the warehouse is the same as the garden tool 110 stored back into the warehouse, an executed action of the management terminal 140 is issuing a work completion prompt. The executed action when the management terminal 140 determines that a garden tool 110 taken out from the warehouse and a garden tool 110 stored back in the warehouse are different is issuing a locking instruction to a lost garden tool 110 to lock the lost garden tool 110. The garden tool 110 is powered off after being locked.

In one embodiment, since a communication between the garden tool 110 and the cloud server 150 may be disconnected, the garden tool 110 cannot be locked through the cloud server 150. At this time, a position of the lost garden tool 110 may be obtained by positioning where the communication module 120 installed on the garden tool 110 is disconnected from the intelligent terminal 130. Alternatively, when the garden tool 110 is in the alarm state, the locking instruction may be automatically triggered to lock the corresponding garden tool 110.

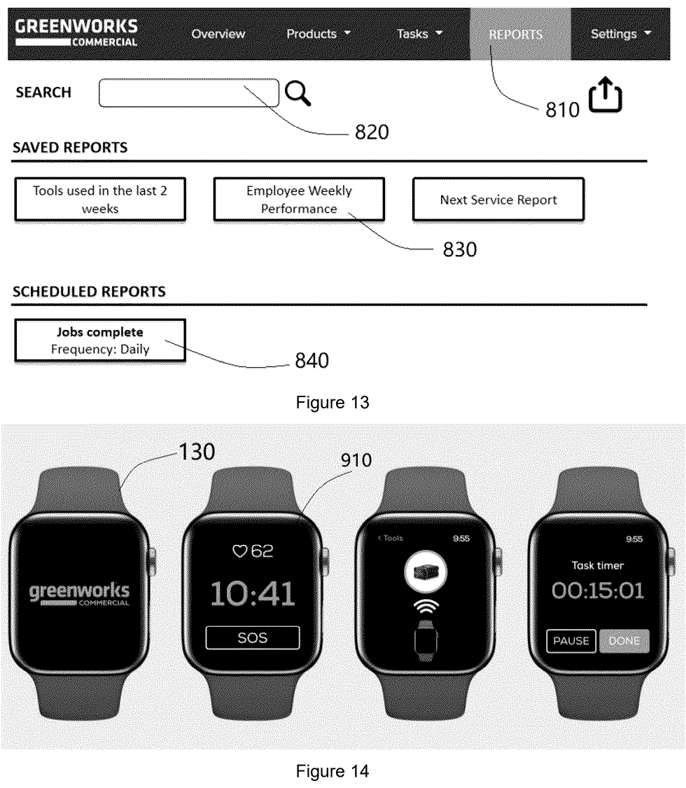

FIG. 13 illustrates a working information display interface 810 displayed in the management terminal 140. The working information display interface 810 of the graphical user interface of the management terminal 140 may display a report search button 820, a report brief information button 830, and a task complete state button 840.

In one embodiment, the operator may click the report search button 820 and enter corresponding search conditions to search for a specific report brief information button 830, and then click the report brief information button 830 to jump to a next interface and obtain detailed historical working information.

In one embodiment, a search may be performed based on a time point when the garden tool 110 was used, or based on a time when the work group was established. The search may further be performed based on a customized date range, the state of the garden tool 110, a state of the operator, the usage time of the garden tool 110, an error code, a remaining duration life of the garden tool 110, etc. Of course, a plurality of the historical working information may be searched at the same time.

In one embodiment, after the search is completed, the obtained historical working information may be saved and exported in a form of a report. An exported file format may be excel, csv, pdf, email, etc., or the report may be printed directly.

In one embodiment, different garden tools 110 have different duration lives. A duration life of each accessory in the same garden tool 110 is also different. The management terminal 140 needs to monitor the different accessories of different garden tool 110 so as to replace accessories that are about to exceed the duration life thereof and prevent problems with the accessories from affecting a safety of the operator.

In one embodiment, the communication module 120 installed on the garden tool 110 may collect usage time periods of the different accessories in the garden tool 110, and send the usage time period of each accessory to the management terminal 140.

In one embodiment, the management terminal 140 may obtain a current usage time period of each accessory. The management terminal 140 may count replacement records and usage time periods of each of the accessories in historical records, and accumulate the usage time periods to obtain a current cumulative usage time period of each accessory. The management terminal 140 may determine whether the usage time period of each of the accessories in the garden tool 110 is close to a corresponding duration life.

In one embodiment, the operator may respectively preset different recommended working time periods for different accessories in different garden tool 110 through the management terminal 140, and save the recommended working time periods in the cloud server 150. After receiving the cumulative usage time periods of each of the accessories, the management terminal 140 may issue different replacement suggestions based on a comparison result between the recommended working time periods of the accessories and the corresponding cumulative usage time periods.

In one embodiment, since different garden tool 110 may send the accumulated usage time periods of a plurality of the different accessories, the management terminal 140 needs to save the accumulated usage times of the different accessories in real time. Since there are the plurality of the accessories, one or more of the accessories may need to be replaced at the same time. When the management terminal 140 issues a normal working instruction or an abnormal working instruction, corresponding information of the accessories may be displayed on the management terminal 140.

In one embodiment, after the management terminal 140 issues the abnormal working instruction, the management terminal 140 needs to determine whether there are spare accessories for the accessories that need to be replaced in the warehouse. Each spare accessory in the warehouse is provided with a different accessory number, and the operator may save the accessory number in the cloud server 150 in advance. The management terminal 140 may issue different instructions by determining whether there is an accessory with a same accessory number as the accessory that needs to be replaced.

In one embodiment, when there is a spare accessory for the accessory that needs to be replaced in the warehouse, the management terminal 140 may issue a replacement instruction to indicate that there is corresponding accessory in the warehouse and may be replaced.

In one embodiment, after completing the replacement of the accessory, the management terminal 140 may issue a replacement success instruction, the management terminal 140 may reset an accumulated usage time period of the accessory, and save the corresponding historical records in the cloud server 150. The historical records may include a type, an accessory model, a replacement time, the accumulated usage time period of the replaced accessory, etc.

In one embodiment, when there is no spare accessory for the accessories that need to be replaced in the warehouse, the management terminal 140 may issue a replacement failure instruction to indicate that there is no corresponding accessory in the warehouse and cannot be replaced. At this time, the management terminal 140 may automatically recommend corresponding spare accessories on a sales market to the operator.

In one embodiment, the operator may also access the management terminal 140 in real time to view inventory and demand of the different spare accessories in the warehouse.

In one embodiment, the management terminal 140 may also calculate based on a current accumulated usage time period, the duration life, an expected work plan and a number of the spare accessories in the warehouse of each accessory of the garden tool 110 to issue a purchase recommendation instruction to the operator in advance. The management terminal 140 can further estimate the working hours according to the work plan, thereby determining whether a state of the current garden tool can meet work requirements. If the work requirements cannot be met, the management terminal 140 will issue a maintenance or replacement instruction in advance. If the accessories are insufficient, the management terminal 140 will issue a purchase recommendation in advance.

In one embodiment, the management terminal 140 may also perform different operations based on comparison results of the inventory and demand of different spare accessories in the warehouse. For example, the management terminal 140 determines that the inventory of spare accessories is greater than or equal to the demand, so that the executed action is not issuing an instruction. The management terminal 140 determines that the inventory of spare accessories is less than the demand, so that the executed action is issuing a purchase recommendation instruction.

FIG. 14 shows an intelligent terminal working interface 910 of the intelligent terminal 130. The intelligent terminal working interface 910 may further display information such as whether the garden tool 110 is successfully connected, whether the garden tool 110 is faulty, and a type of garden tool 110 recommended for a current task.

In one embodiment, the intelligent terminal 130 can not only serve as a data transfer station, but also serve as an auxiliary tool for the operator to help the operator complete the work smoothly. The intelligent terminal 130 can be bound to the garden tool 110 and the operator respectively to obtain information about the garden tool 110 and operator's health state.

In one embodiment, the information of the garden tool 110 may include planned working hours of the current garden tool 110, the current working hours of the current garden tool 110, and the like.

In one embodiment, the operator's health state may include heart rate, blood pressure, blood oxygen, blood sugar, etc. At the same time, the operator's health state may also be monitored in real time through the intelligent terminal to protect an operator's health.

Please refer to FIG. 14. The intelligent terminal 130 may compare the operator's health state with preset conditions and send different alarm message to the cloud server 150 based on comparison results.

In one embodiment, a heart rate monitoring is taken as an example for description. Under normal circumstances, the operator's heart rate is in a range of 60 to 100 beats per minute. The intelligent terminal 130 may monitor the operator's heart rate in real time. If the operator's heart rate is within 60 to 100 beats per minute, the intelligent terminal 130 may send a normal message to the cloud server 150 at this time. If the operator's heart rate is less than 60 beats per minute, the intelligent terminal 130 may send a slow heart rate alarm message to the cloud server 150 at this time. If the operator's heart rate is greater than 100 beats per minute, the intelligent terminal 130 may send a fast heart rate alarm message to the cloud server 150 at this time.

In one embodiment, when the intelligent terminal 130 sends the alarm message to the cloud server 150, the cloud server 150 sends the alarm to the operator to suggest the operator to stop working. In addition, the cloud server 150 can further find other nearby intelligent terminals 130 based on positioning information of the intelligent terminal 130, and send the alarm message to other nearby intelligent terminals 130 to remind other staff that an operator needs help. Alternatively, the cloud server 150 may also send the alarm message to the management terminal 140 based on the positioning information of the intelligent terminal 130 to remind a management staff that a certain operator needs help.

In one embodiment, the intelligent terminal 130 may also be capable of actively issuing different alarm messages. For example, when the operator is unable to continue working due to physical discomfort, he or she may actively click an “SOS” button on the intelligent terminal working interface 910, which means a one-touch alarm button. At this time, the intelligent terminal 130 may also send the alarm message to the cloud server 150 to seek help from other staff.

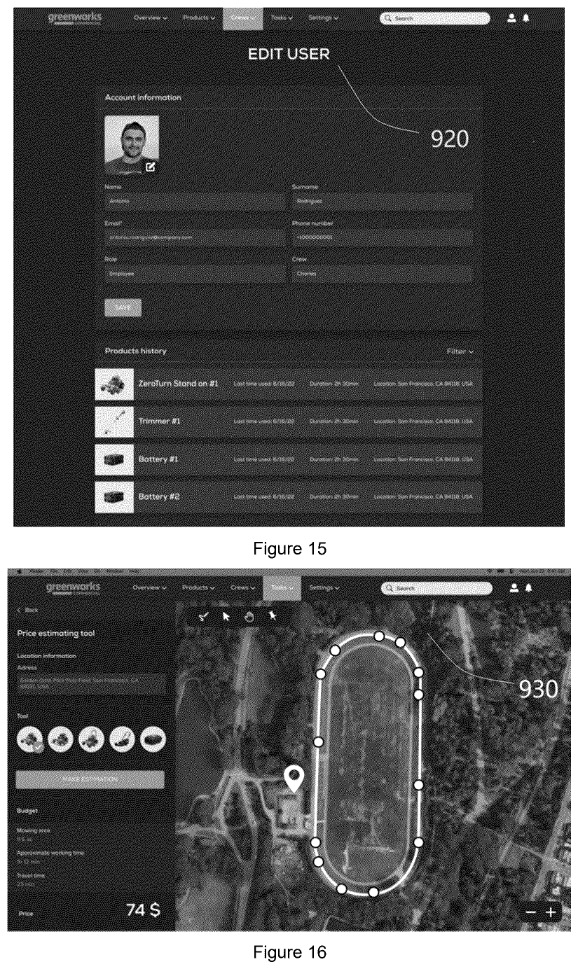

FIG. 15 shows a personnel history record interface 920 of the intelligent terminal 130. The operator information may be input on the intelligent terminal 130 to bind the operator to the intelligent terminal 130 and obtain operator's historical work records.

In one embodiment, the historical work records may be displayed on the personnel history record interface 920. The personnel history record interface 920 may display the operator's personal information and information about the used garden tool 110.

In an embodiment, the operator's personal information may include the name, the photo, the mobile phone number, the email address, the title, etc. The information of the used garden tool 110 may include a device category, a device name, a device photo, a device management number, a device brand, a device usage position, etc.

FIG. 16 shows a working task generation interface 930 of the intelligent terminal 130. The working task generation interface 930 may be generated on the management terminal 140 and/or the intelligent terminal 130.

In one embodiment, when the operator or a manager receives an order consultation, he or she may use the pan and zoom controls on the map of the working task generation interface 930 to focus the map on a specific area according to requirements of an order, and operate the drawing tools to draw boundaries of a work position to form a working area. The boundaries created by the operator using the drawing tool may be customized for the work sites that are regularly shaped, irregularly shaped, scattered along streets, etc.

Please refer to FIG. 16. After completing a drawing of the boundary of the working area, the number of the required staffs, the type of garden tool 110 required, the number of garden tools 110 and the usage time period, etc. may be calculated based on a time limit and quality required by the order to generate corresponding quotation information.

In one embodiment, the quotation information may be sent to a customer. If the customer agrees to the order, order information is integrated to form a new working task and uploaded to the cloud server 150. The cloud server 150 may send the working tasks to the appropriate intelligent terminals 130 according to the order information to form a work group to complete the order.

In one embodiment, when the work group is ready to perform the working task, the management terminal 140 or the cloud server 150 may split the working task into multiple subtasks and assign them to various operators.

In one embodiment, a task start button and a task complete button may be arranged on the intelligent terminal working interface 910 of the operator's intelligent terminal 130. When the operator clicks the task start button, it may indicate the start of processing the subtask. When the operator clicks the task complete button, it may indicate that a subtask processing is completed and it may automatically jump to the next subtask. When the operator is processing the working task, the intelligent terminal 130 can upload a working progress to the cloud server 150 in real time.

In one embodiment, the administrator may view a task progress, a completion state, each operator's position, work efficiency and other information of different work groups through the management terminal 140, and can also view work data of the garden tool 110 used in the working task in real time, such as a start time of work, a stop time of work, the working hours, the position, the remaining power, etc.

In one embodiment, when the work group is performing a working task, the operator will pair and bind the intelligent terminal 130 with a certain garden tool 110. Before the intelligent terminal 130 is paired with the garden tool 110, the garden tool 110 cannot work normally. Only after the intelligent terminal 130 is successfully paired with the garden tool 110 can the garden tool 110 work normally.

In one embodiment, the same intelligent terminal 130 can only be paired with one garden tool 110. When the intelligent terminal 130 needs to be paired with other garden tool 110, after a pairing is successful, the previous garden tool 110 will automatically cancel a pairing state, and at this time the previous garden tool 110 cannot work normally.

In one embodiment, the following description will be made by taking the garden tool 110 as a wheeled device such as the mower as an example. Before the mower is paired with the intelligent terminal 130, the mower enters a turn-off state or the limp state. At this time, the cutter of the mower will not run, and the walking function of the mower may be limited to low speed walking or stop walking. After the mower is successfully paired with the intelligent terminal 130, the mower may work normally.

In one embodiment, the following description will be made by taking the garden tool 110 as a handheld electric saw or other garden tool as an example. Before the handheld electric saw is paired with the intelligent terminal 130, the handheld electric saw cannot be used, and only information such as a battery power and whether there is a fault can be displayed on the handheld electric saw. After the handheld electric saw is successfully paired with the intelligent terminal 130, the handheld electric saw may work normally.

In an embodiment, the trailer 210 may be a transport vehicle. When a new working task is generated, the trailer 210 may transport the work group and the required garden tools 110 to the working area to complete the working task.

In one embodiment, the trailer 210 may be provided with a charging device, which can charge the garden tool 110, the intelligent terminal 130, and the like. The trailer 210 may further be connected to an external AC power source port or DC power source port to obtain external power to supplement power consumed by the charging device. The trailer 210 may be provided with an energy storage device, which can be charged by the charging device to supply power to the garden tool 110 in the working area. Of course, the trailer 210 may also be provided with solar panels to supplement the power of the charging device.

In an embodiment of the disclosure, the trailer 210 may be provided with the gateway, the gateway may be communicated with the garden tool 110, and the intelligent terminal 130, the management terminal 140 and the cloud server 150 to upload the working information and the operator information through the gateway.

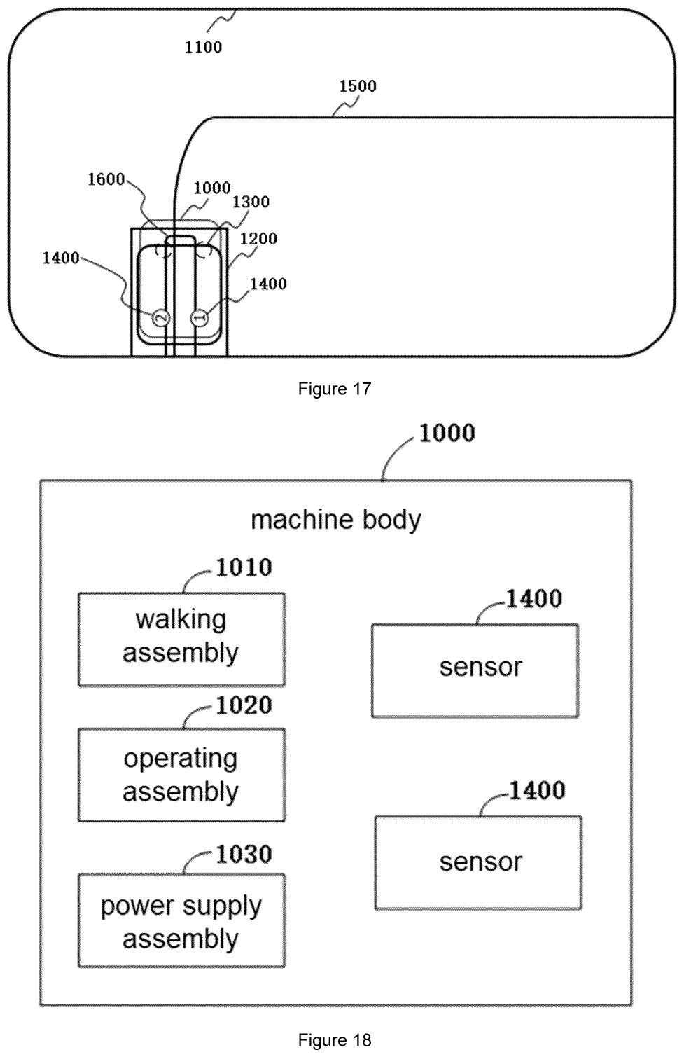

FIG. 17 shows a schematic view of a management system 100 managing a mower system. A mower 1000 needs to frequently return to a charging station 1200 for charging. After being charged, the mower 1000 will leave the charging station 1200 and return to a different mowing area to work, and automatically work according to a working mode set by the operator on the intelligent terminal 130. The mower 1000 may be a self-propelled mower, which is a garden tool that is battery-powered and requires regular charging. During use, the mower 1000 may move and work within a working area defined by a boundary wire 1100.

In one embodiment, the mower system may include the mower 1000, the boundary wire 1100, the charging station 1200, and a guide wire 1500. The mower 1000 may include a machine body and at least one sensor 1400 (FIG. 17) shows a situation where the mower 1000 includes two sensors 1400, the first sensor is indicated by \textcircled{1} in FIG. 17, and the second sensor is indicated by \textcircled{2} in FIG. 17).

In one embodiment, the sensor 1400 is arranged at a front or rear end of the machine body. The sensor 1400 is used to sense a guide signal of at least one of the boundary wire 1100, the guide wire 1500, and a charging station outfield loop 1300. The mower 1000 automatically leaves the charging station 1200 according to the guide signal.

Please refer to FIG. 17 and FIG. 26. The guide wire 1500 is pre-laid in the working area of the mower 1000. Two ends of the guide wire 1500 are connected with the charging station 1200 and the boundary wire 1100 respectively. One end of the guide wire 1500 connected with the charging station 1200 is also connected with the boundary wire 1100, so that the guide wire 1500 and a relatively short part of the boundary wire 1100 between the two end points of the guide wire 1500 together form a closed loop.

In one embodiment, the charging station 1200 is located on the boundary wire 1100 and is configured as a charging plate to facilitate the mower 1000 to be located on a uniform and continuous plane during a connecting process, thereby ensuring a more accurate connecting process.

In one embodiment, in order to facilitate the mower 1000 to identify the position of the charging station 1200, the outfield loop 1300 is arranged in the charging station 1200. At the position of charging station 1200, the boundary wire 1100 is concave into the working area to form an infield loop 1600. The infield loop 1600 is narrower than the outfield loop 1300 and passes through it. The infield loop 1600 is used to guide the mower 1000 to exit the charging station 1200.

Please refer to FIG. 17. The boundary wire 1100 may be buried along an edge of the working area to hide the boundary wire 1100, or may be arranged on a ground or on a surface. The boundary wire 1100 may be a single-core metal wire (e.g., a copper wire) or a multi-strand wire.

In one embodiment, the guide wire 1500 may be buried in the working area to hide the boundary wire 1100, or may be set on the ground or on the surface. The sensor 1400 may be a magnetic field sensor or a current sensor to detect the guide signal of at least one of the boundary wire 1100, the guide wire 1500, and the outfield loop 1300.

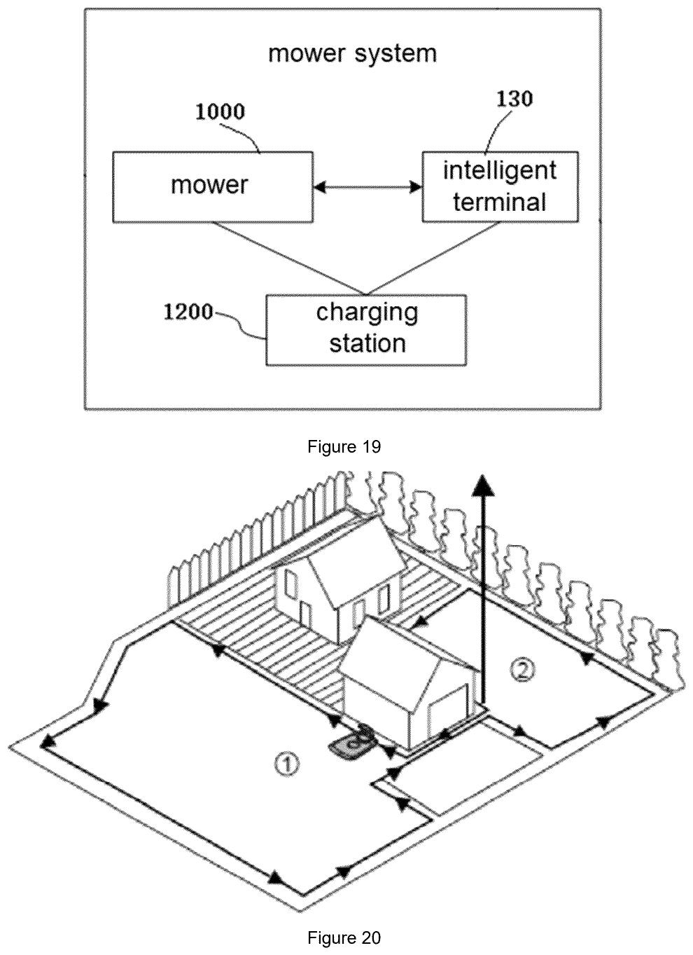

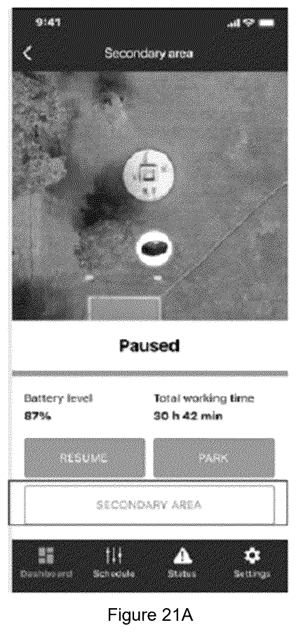

Please refer to FIG. 18. The mower 1000 includes a walking assembly 1010, an operating assembly 1020, and a power supply assembly 1030, which are arranged on the machine body of the mower.

In one embodiment, the walking assembly 1010 includes driving wheels located on two sides of the machine body. The driving wheels are typically located at a rear of the machine body. The two driving wheels are driven by two driving motors, respectively. At least one supporting wheel is further arranged at a front of the machine body. The mower 1000 is supported by the driving wheels and the supporting wheel. The supporting wheel may be a universal wheel to facilitate a steering of the mower 1000.

In an embodiment, the operating assembly 1020 includes a cutting motor and a cutting head driven by the cutting motor. The operating assembly 1020 is located approximately in a center of mower 1000. A rotating shaft of the cutting motor is approximately perpendicular to a horizontal plane. A height of operating assembly 1020 from the ground may be adjusted by the operator to achieve an adjustment of a cutting height.

In one embodiment, the power supply assembly 1030 includes a rechargeable battery and a charging system for supplying power to the rechargeable battery. The mower 1000 receives various signals sent to the mower 1000 or signals collected by the sensor 1400, and generates corresponding control signals through a built-in processor, and controls a walking unit or an operating unit according to the generated control signals, so that the mower 1000 leaves the charging station 1200 along a planned path to mow.

In one embodiment, an example is given in which the guide signal is an alternating magnetic field and the sensor 1400 is a magnetic induction coil. It may be understood that, other suitable guide signal forms or different types of sensors may also be used. A signal generating device may input an alternating pulse current signal into the boundary wire 1100, the guide wire 1500 or the outfield loop 1300, thereby generating the alternating magnetic field around the boundary wire 1100, the guide wire 1500 or the outfield loop 1300.

In one embodiment, the sensor 1400 may be the magnetic induction coil. A sensing principle is that, based on a magnetic induction effect, when the alternating pulse current is input into the boundary wire 1100, the guide wire 1500 or the outfield loop 1300, the alternating magnetic field may be generated around the boundary wire 1100, the guide wire 1500 or the outfield loop 1300. When the magnetic induction coil is located near the boundary wire 1100, the guide wire 1500 or the outfield loop 1300, the magnetic induction coil will generate an induced electromotive force in the alternating magnetic field, thereby generating an induced current in the magnetic induction coil. The induced current is filtered and amplified before being sent to the mower 1000. A position and orientation of the mower 1000 relative to the boundary wire 1100, the guide wire 1500 or the outfield loop 1300 are determined based on a magnitude and polarity of the induced current.

FIG. 19 shows a functional module view of the mower system. According to functions to be implemented, the mower system includes the mower 1000, the charging station 1200, and the intelligent terminal 130. The mower 1000 works within the working area defined by the boundary wire 1100. The intelligent terminal 130 is connected with the mower 1000 and is used to set working parameters of the mower 1000.

In one embodiment, the working area is divided into a main working area and a secondary working area. When the mower 1000 is located in the main working area, based on the intelligent terminal 130, the mower 1000 operates in a first working state. When the mower 1000 is located in the secondary working area, based on the intelligent terminal 130, the mower 1000 operates in a second working state.

Please refer to FIG. 20. The charging station 1200 is arranged in the main working area (shown as (1) in FIG. 20), and no charging station 1200 is arranged in the secondary working area (shown as (2) in FIG. 20).

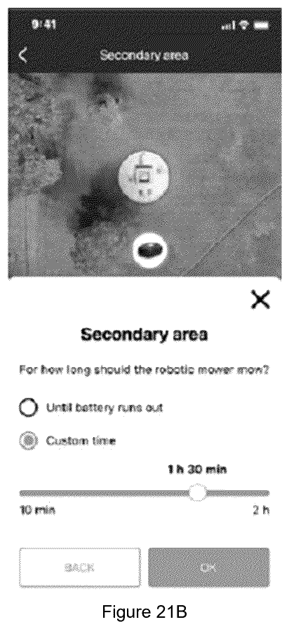

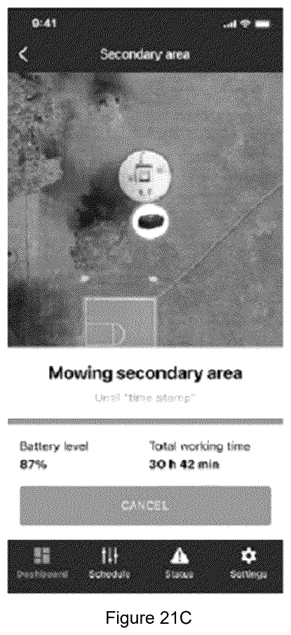

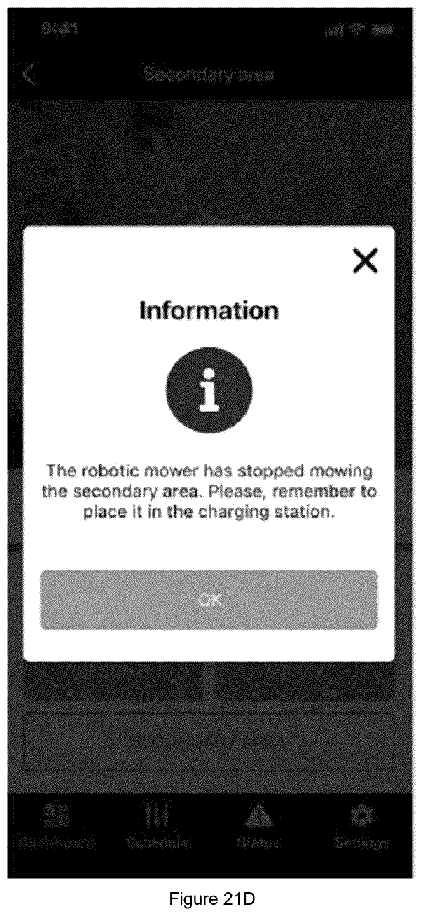

Please refer to FIG. 21. There are often individual areas in the working area of the mower, such as a backyard, which cannot be connected to the main working area of the mower 1000 or a passage is too narrow for the mower 1000 to pass through. If the charging station 1200 is separately arranged in this area, a cost will increase. Therefore, the working area of the mower 1000 may be set as the main/secondary working area.

In an embodiment, no charging station 1200 is arranged in the secondary working area. The mower 1000 may be manually placed from the main working area to the secondary working area by the operator.

Please refer to FIGS. 21A, 21B, 21D and 21D. After confirming that the mower 1000 is located in the secondary working area, a time for the mower 1000 to work in the secondary working area may be set through the intelligent terminal 130 (at the same time, during the work of the mower 1000, the operator may issue a stop command to stop the mower 1000 from working in the secondary working area, or to work for a certain time). When a preset time is reached, the operator may be reminded that mowing work has been completed and may take the mower 1000 back to the charging station 1200 in the main working area for charging.

In one embodiment, a user terminal corresponding to the mower 1000 may be controlled to confirm that the mower is located in the secondary working area, and before moving the mower 1000, it may be confirmed that the mower is in a stopping state.

In an embodiment, in the first working state, when power of the mower 1000 is lower than a threshold, the mower 1000 returns to the charging station 1200 for charging. For example, the mower 1000 may return to the charging station 1200 for charging according to the guide wire 1500.

In an embodiment, in the second working state, when power of the mower 1000 is lower than a threshold, the mower 1000 continues to work and sends a notification to the intelligent terminal. In the second working state, the mower 1000 may continue to work until the power is exhausted, or send the notification to the operator to remind the operator that the power is too low.

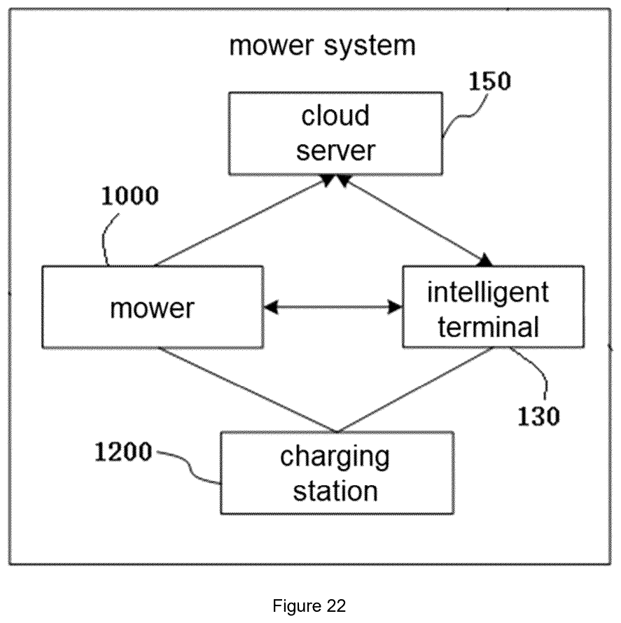

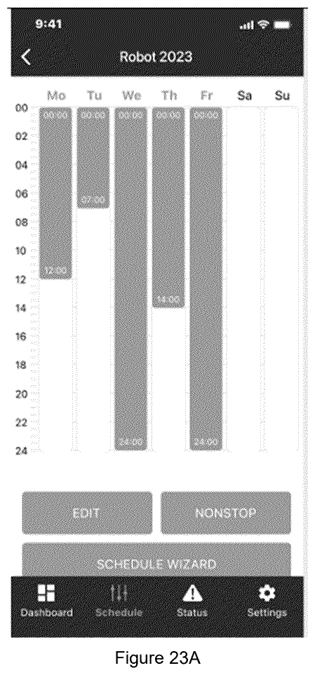

Please refer to FIG. 22. The mower system further includes the cloud server 150, and both the mower 1000 and the intelligent terminal 130 can be connected to the cloud server 150. The cloud server 150 stores parameters of the mower 1000 set by the intelligent terminal 130.

In one embodiment, the operator may estimate the time according to a completion state of mowing work in the working area and set a working time of the mower 1000 through the intelligent terminal 130. When the mower 1000 is working, the intelligent terminal 130 may visually display a remaining completion time to remind the operator.

In one embodiment, after a mowing operation begins, the intelligent terminal 130 is used to set a working schedule for the mower 1000 and switch a working mode of the mower 1000. The working modes of the mower 1000 include a working schedule working mode, a pause working mode and a continuous working mode.

In one embodiment, a mowing condition may be a condition where lawn has too much grass due to some reason, such as not being cleaned for several days or being cut for the first time, and thus requires a long time to mow. Alternatively, the operator may not need to mow the lawn regularly for some reason, such as continuous rainy days, severe lawn degradation, or traveling far away, or the operator may need to set a regular mowing schedule to mow the lawn in order to maintain daily maintenance.

In one embodiment, the scheduled working mode may be a fixed working time to regularly mow. For example, working from 8:00 am to 10:00 am on Tuesdays, Thursdays, and Saturdays.

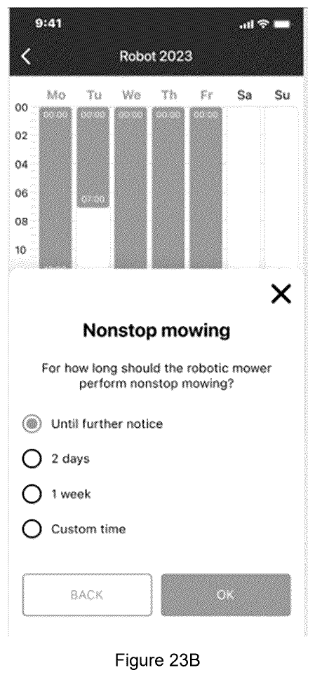

Please refer to FIG. 23A and FIG. 23B. The continuous working mode may be continuous mowing without setting the working time. During this period, when the power of the mower 1000 is lower than the threshold, the mower 1000 may return to the charging station 1200 for charging. After being fully charged, the mower 1000 will continue to work, or the intelligent terminal 130 will stop after switching the working mode.

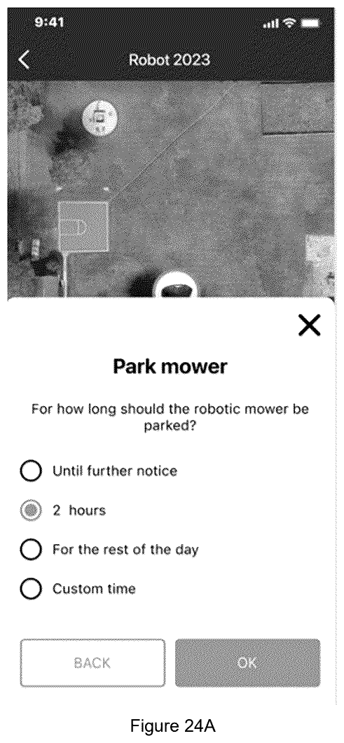

Please refer to FIG. 24A and FIG. 24B. The pause working mode may be customized according to user needs or selected according to optional conditions. For example, it may be set to “until further notice” or set it to mow after two days. Specifically, the intelligent terminal 130 may switch between different working modes according to actual needs to control the mower 1000 to mow.

In one embodiment, the pause working mode or the continuous working mode is set to different time periods or to perform a current operation until further notification.

In one embodiment, the intelligent terminal 130 is further configured to set a working starting point for the mower 1000, and at least one working starting point is set. The intelligent terminal 130 may set the working starting point of the mower 1000 according to a following method: obtaining area parameters of the lawn, and setting a plurality of the working starting points according to the area parameters. The area parameters include parameters corresponding to the charging station 1200 and the guide wire 1500.

In an embodiment, the area parameters include parameters corresponding to the charging station 1200 and the guide wire 1500, a size of the lawn, and the like. Data and a distance of the working starting point may be set through the area parameters. The working starting point may be set at the charging station 1200 or the guide wire 1500.

In one embodiment, setting the plurality of the working starting points according to the area parameters includes that: first, determining the number of starting points according to the area parameters; second, selecting charging station parameters and guide wire parameters according to the area parameters; finally, generating a charging station starting point and a guide wire starting point according to the number of the starting points, the charging station parameters and the guide wire parameters, and using the charging station starting point and the guide wire starting point as the working starting points.

In one embodiment, the number of the starting points may be set according to the size of the lawn in the area parameters, or according to user desire. After the number of the starting points is determined, the number of the starting points may be divided between the charging station 1200 and the guide wire 1500, which means that the number of the starting points set for the charging station 1200 and the number of the starting points set for the guide wire 1500 are determined.

In one embodiment, the starting point set at the charging station 1200 may be a position of the sensor 1400 of the mower 1000 when the sensor exits the outfield loop 1300. The starting points set on the guide wire 1500 may be set on the guide wire 1500 at a fixed division distance according to an allocated number of the starting points of the guide wire, or may be set on the guide wire 1500 in a random arrangement manner.

In one embodiment, the starting points may be set at positions other than the charging station 1200 or the guide wire 1500 in the above embodiments. The working starting points of the mower 1000 may also be selected from a plurality of working starting points according to a preset rule.

In one embodiment, the intelligent terminal 130 is used to set a frequency at which the mower 1000 starts working at different working starting points. A preset rule is to select a target starting point set from starting points of the charging station and the starting points of guide wire according to a preset selection ratio. A starting point is randomly selected from the target starting point set as a target work starting point. Wherein, the preset selection ratio may be 30% for the starting points of the charging station 1200 and 70% for the starting points of the guide wire.

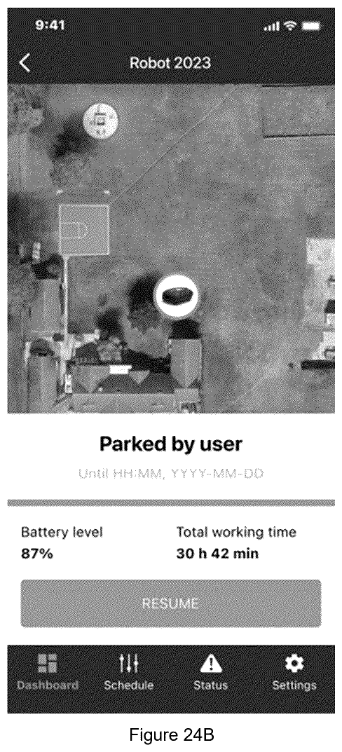

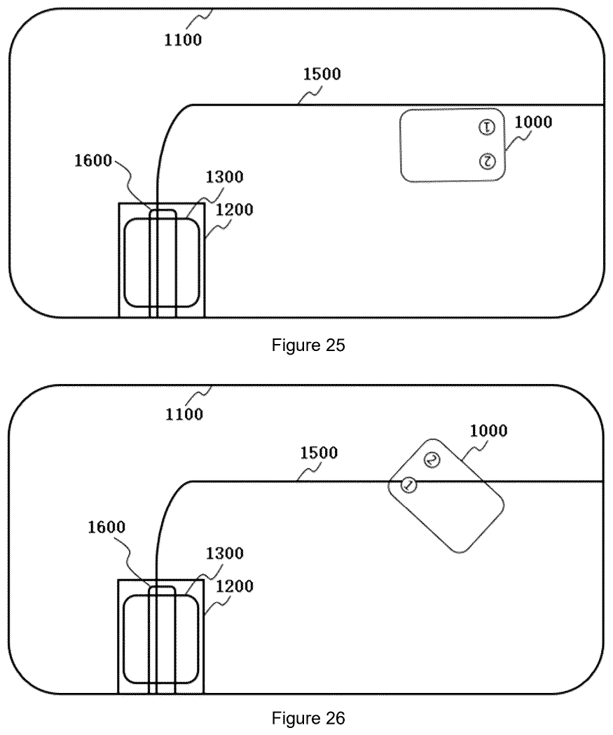

Please refer to FIG. 25. The working starting point at the guide wire 1500 is a position where the mower 1000 exits the charging station 1200 along the guide wire 1500 and walks a certain distance, the certain distance may be set by the intelligent terminal 130.

In one embodiment, the mower 1000 follows the guide wire 1500 along a different path each time to move toward a target position, thereby avoiding repeated rolling to form ruts that affect a growth of the lawn or vegetation in a rutted area.

Please refer to FIG. 26. After a lawn mowing begins, the mower 1000 may randomly rotate an angle and then begin the lawn mowing within the working area defined by the boundary wire 1100.

In one embodiment, the mower 1000 may randomly mow within the working area. During a random mowing, the mower 1000 may randomly rotate 0-360 degrees. When the mower 1000 randomly rotates in a random direction to mow forward, the mower 1000 will move in a straight line until it reaches the boundary wire 1100. After reaching the boundary wire 1100, the mower 1000 will randomly rotate inward at an angle to mow.

In one embodiment, through selecting the different working starting points and controlling the mower 1000 to start mowing when it reaches the target work starting point, it is avoided that the mower 1000 repeatedly uses a same position as the starting point every time it mows, which causes the lawn at the fixed starting point to be severely worn relative to other areas.

In one embodiment, the intelligent terminal 130 is used to set a maximum distance that the mower 1000 may walk along the boundary wire 1100 or the charging station 1200. The intelligent terminal 130 is used to control the mower 1000 to automatically move along the boundary wire 1100 or the guide wire 1500 to test whether set parameters are correct.

In one embodiment, an interval distance when the mower 1000 follows the guide wire 1500, or the maximum distance that the mower 1000 needs to maintain when mowing at the boundary wire 1100, may be obtained by adjusting the parameters of the mower 1000 for multiple times. Each time, the mower 1000 may select a different target distance from the interval distance or the maximum distance. Through selecting a different target distance, the mower 1000 may be prevented from going out of the boundary or forming a crushing trace.

In one embodiment, the interval distance of the mower 1000 at the guide wire 1500 and the maximum distance at the boundary wire 1100 need to be tested in advance. First, the interval distance of the mower 1000 on the guide wire 1500 and the maximum distance on the boundary wire 1100 are set respectively, and then the mower 1000 is controlled to move along the boundary wire 1100 or the guide wire 1500. After the operator confirms that the mower 1000 is operating normally, it means that the selected interval distance and the maximum distance meet an actual walking requirement.

In one embodiment, if the operator confirms that the mower 1000 is not working normally, the operator readjusts the parameters of the mower 1000, resets the interval distance and the maximum distance, and retests. The interval distance corresponding to the guide wire 1500 and the maximum distance corresponding to the boundary wire 1100 may be located on either side of a line. The interval distance and the maximum distance may be set and tested together according to a same standard, or different distances may be set and tested separately.

In one embodiment, before mowing and when testing the interval distance of the guide wire 1500 and the maximum distance of the boundary wire 1100, a blade of the mower 1000 is in the stopping state to prevent safety accidents.

In the above mower system, different working areas are set for mowing, thereby avoiding a problem of repeatedly arranging the charging station 1200 in each working area, which in turn leads to increased costs. Through selecting target modes from a variety of working modes, usage view of the mower are expanded, which enables a use of the mower to be more flexible. Through setting the working starting points according to the area parameters in the lawn (such as parameters of the charging station 1200 and parameters of the guide wire 1500), the mower may have more options when starting mowing, which enables a start of mowing to be more random. At the same time, it is avoided a problem that the mower repeatedly uses the same position as the starting point every time it mows, which causes the lawn at the fixed starting point to be severely worn relative to other areas. It may solve a problem that the mower cannot adapt to different working areas and different mowing conditions.

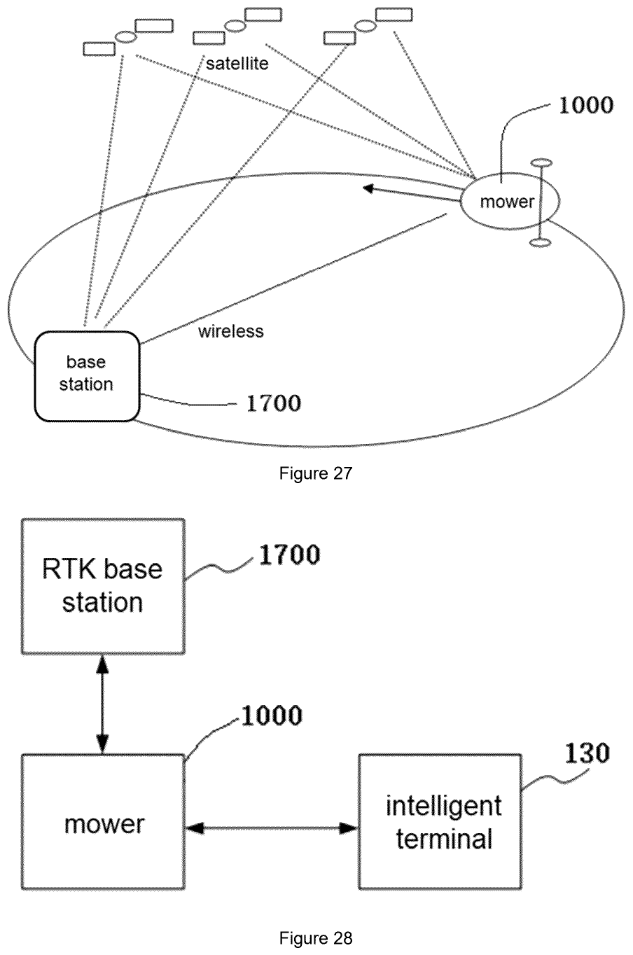

FIG. 27 shows a schematic view of a positioning of the mower by the management system 100. The mower may be positioned through RTK differential positioning technology. RTK differential positioning technology is a real-time differential GPS technology based on carrier phase observation. It includes three parts: a standard station receiver, a data link, and a mobile station receiver.

In one embodiment, receivers of a carrier standard station and a mobile station continuously monitor a same satellite, and when the mobile station receives and observes a visible satellite signal, the standard station sends a carrier phase measurement value to the mobile station receiver in real time through the data link. The mobile station receiver processes its own carrier phase measurement value and the received carrier phase measurement value in real time to calculate its own spatial coordinates and complete a high-accuracy positioning. Wherein, a base station acts as the standard station and the mower acts as the mobile station.

FIG. 28 shows a schematic view of a positioning and a management of the mower by the management system 100. The management system 100 may include the mower, the intelligent terminal 130 and the base station.

In one embodiment, the operator can interact with the mower based on an application on the intelligent terminal 130, issue control instructions to the mower, or receive the working state, operating parameter data, etc. sent by the mower to control the mower.

In one embodiment, the base station may be an RTK base station 1700 for positioning the mower based on the RTK differential positioning technology shown in FIG. 27. It may be understood that, the mower may also be a garden tool such as an intelligent snow blower, an intelligent hedge trimmer, etc. that is positioned through the RTK differential positioning technology and may interact with the intelligent terminal 130.

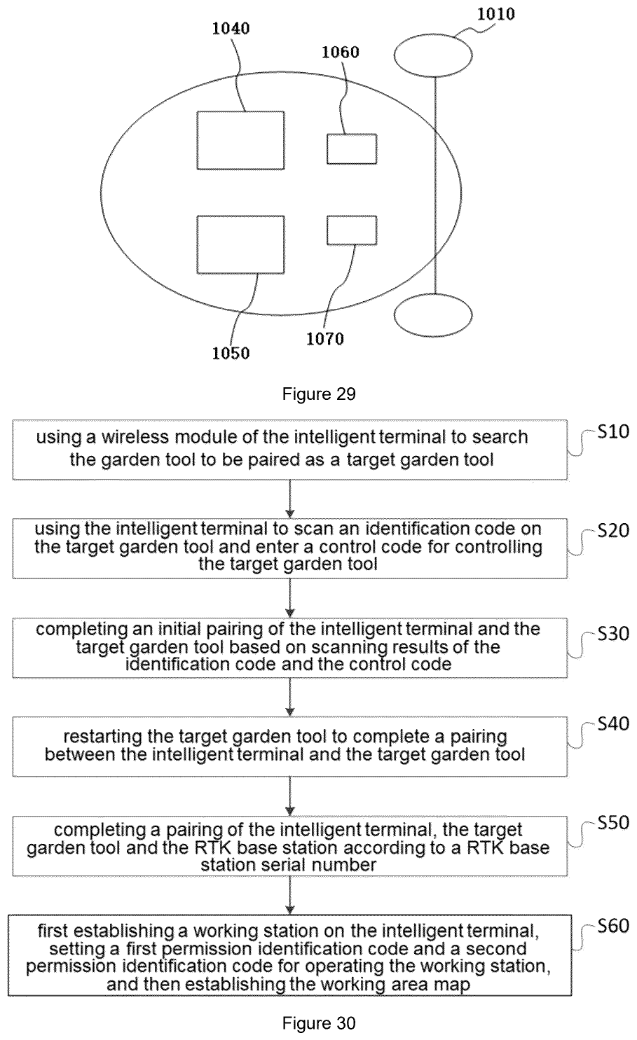

Please refer to FIG. 29. The mower may further include a path planning module 1040, a control module 1050, a storage module 1060 and a positioning module 1070.

The walking assembly 1010 is connected with the control module 1050 and can walk under control instructions of the control module 1050 to drive the mower forward, backward and turn.

The path planning module 1040 is connected with the control module 1050. The path planning module 1040 is used to plan an operating path of the mower in the working area according to a working area map of the mower.

The control module 1050 includes a communication device that can exchange data with the intelligent terminal 130 to generate the control instructions to control module mechanisms and other actions in the mower, and may also transmit relevant operating data to the intelligent terminal 130.

The storage module 1060 is used to store a working area map and control a program of the mower.

The positioning module 1070 can position the mower based on satellite navigation signals. As an example, the positioning module 1070 may position the mower based on the RTK differential positioning technology as shown in FIG. 27.

FIG. 30 is a flowchart showing a management method of the garden tool for a positioning management of the mower, and the management method may be applied to the above-mentioned management system. When the management method performs the positioning management on the position of the garden tool 110, the following operations may be included:
using a wireless module of the intelligent terminal to search the garden tool to be paired as a target garden tool;
using the intelligent terminal to scan an identification code on the target garden tool and enter a control code for controlling the target garden tool, wherein the identification code is a QR code set on the machine body of the garden tool;
completing an initial pairing of the intelligent terminal and the target garden tool based on scanning results of the identification code and the control code;
restarting the target garden tool to complete a pairing between the intelligent terminal and the target garden tool;
completing a pairing of the intelligent terminal, the target garden tool and the RTK base station according to a RTK base station serial number; and
first establishing a working station on the intelligent terminal, setting a first permission identification code and a second permission identification code for operating the working station, and then establishing the working area map.

In one embodiment, the mower needs to be paired with the intelligent terminal 130 before use. Before pairing, it is necessary to turn on the application and wireless module of the intelligent terminal 130, and then use the wireless module to find the mower to be paired. The wireless module may be a Bluetooth module.

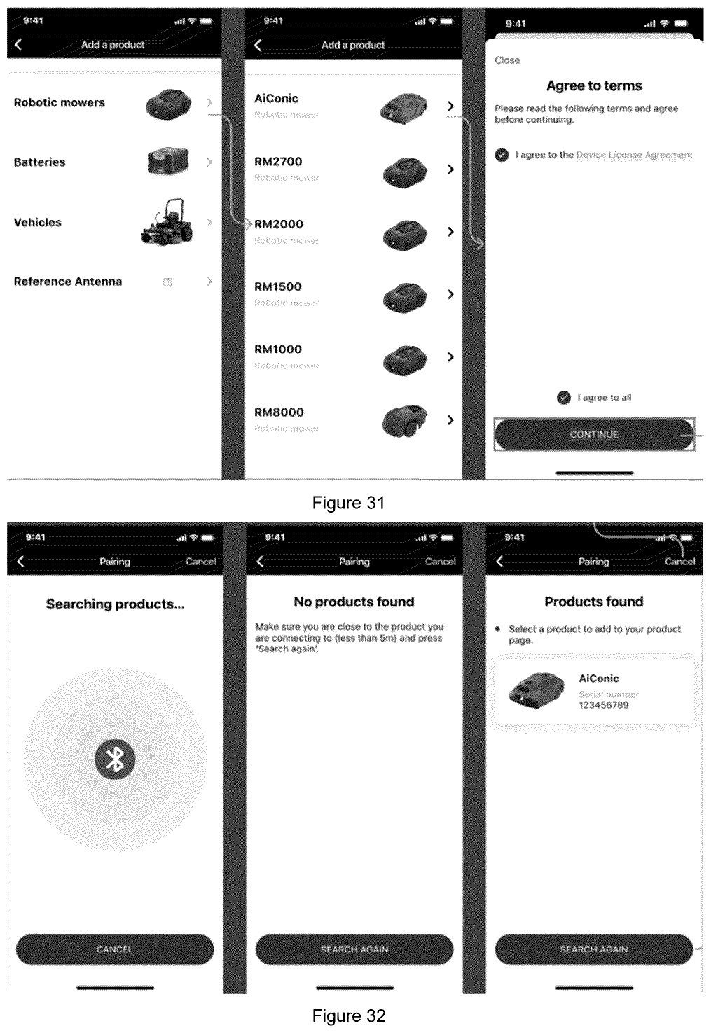

Please refer to FIG. 31 and FIG. 32. In order to avoid many useless results when using the wireless module to find the paring mower, and to find the paring mower more accurately, as shown in FIG. 31, a same tool type as the mower type (AiConic in FIG. 31) may be first selected in an application interface of the intelligent terminal 130. Then, please refer to FIG. 32. Based on a selected tool type, the wireless module of the intelligent terminal 130 is used to search for the mower to be paired, such as the mower in FIG. 32, as the target garden tool.

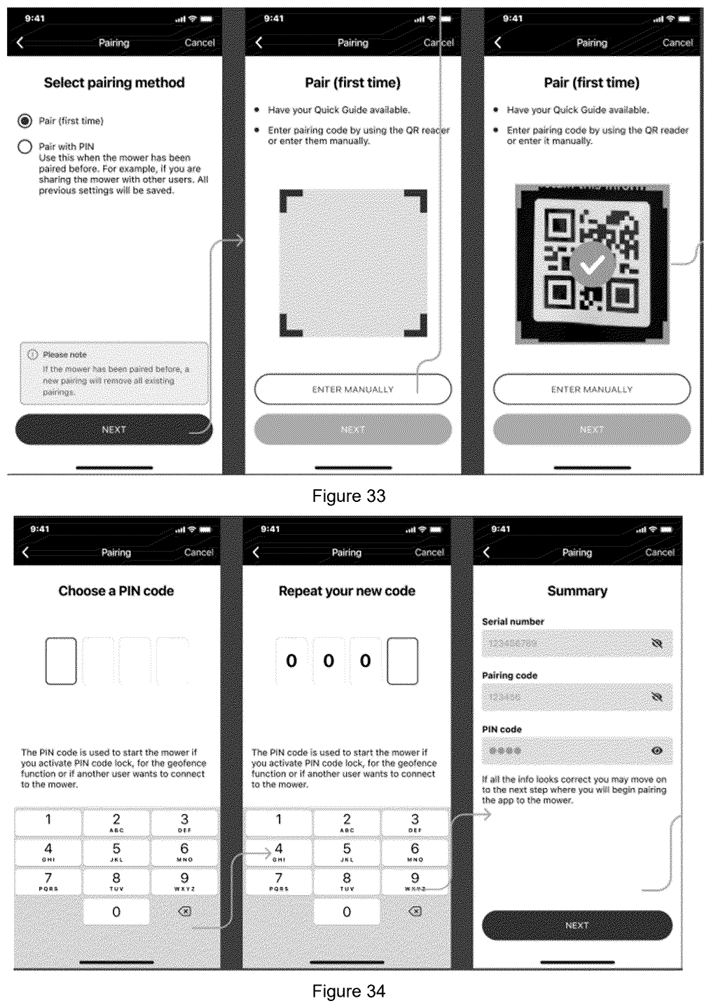

Please refer to FIG. 33. When the mower to be paired is found, an interface for selecting the pairing method will pop up. During a first pairing, a first pairing mode is selected, and the intelligent terminal 130 is used to scan and identify the QR code on the mower to set relevant information of the mower including a pairing code and a serial number.

Please refer to FIG. 34. Then a PIN setting interface appears, the operator enters the PIN code as the control code for controlling the mower on this interface, and jumps to a pairing information display interface (a rightmost interface in FIG. 34). The pairing information display interface will display the pairing code, the serial number, the control code and other information for the operator to confirm. After the operator confirms that the information is correct, the initial pairing of the intelligent terminal 130 and the mower is completed.

In one embodiment, the control code is used by the operator of the mower when it is not a first time to pair the mower. Of course, the control code may also be shared with other users of the mower for pairing, thereby achieving a permission sharing.

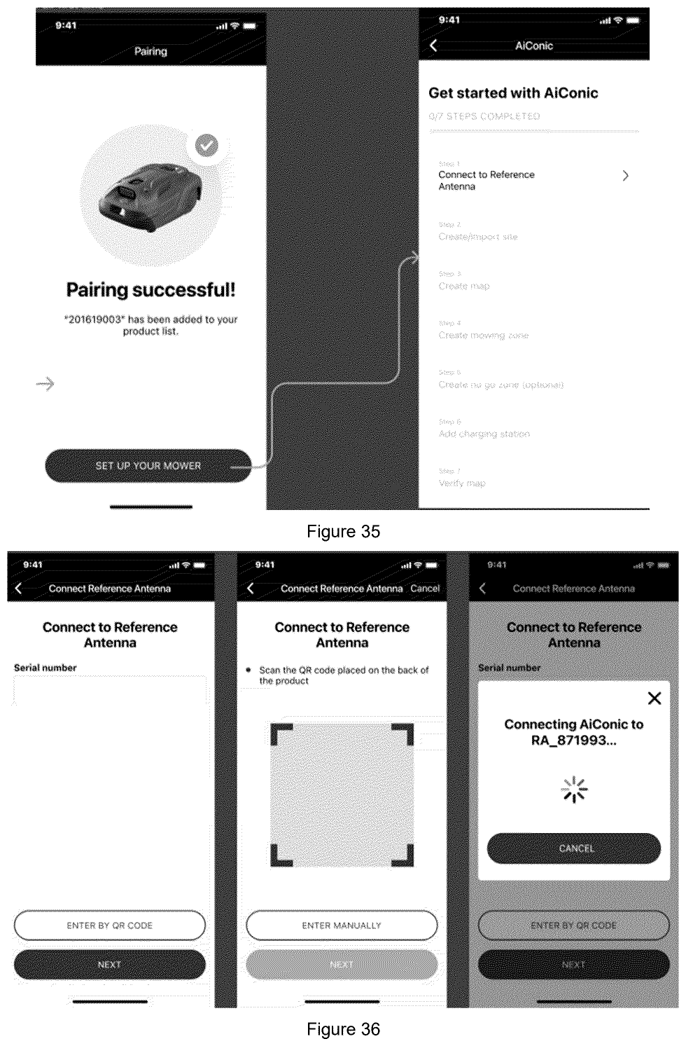

In one embodiment, after the initial pairing is completed, the mower needs to be restarted to finally complete the pairing of the intelligent terminal 130 and the mower. Please refer to FIG. 35. The operator may restart the mower using a safety key on the mower according to a restart prompt message on the application interface. When the mower is restarted and reconnected to the application of the intelligent terminal 130, after the mower is named, a pairing success interface as shown in a left interface of FIG. 35 will be displayed in the application, indicating that the pairing of the intelligent terminal 130 and the mower is completed.

In one embodiment, a transfer button (SET UP YOUR MOWER) on the left interface is clicked to transfer to a mower configuration interface on a right side of FIG. 35 to perform subsequent operations such as a pairing of the RTK base station 1700, a point setting, and a map establishment.

In one embodiment, after the pairing is completed, the QR code on the mower and an application account of the intelligent terminal 130 will automatically establish a binding relationship. When the QR code is scanned using an application of another account, it will not take effect and the pairing with the mower cannot be completed. Only after an existing binding relationship is released can the applications of other accounts be bound to the mower, thereby preventing information leakage and enabling the garden tool to be safer and more convenient to manage.

Please refer to FIG. 36. In one embodiment, there are a plurality of the RTK base stations 1700 in the working area of the mower generally. In order to avoid a problem of poor positioning accuracy caused by using different RTK base stations 1700 during mapping and actual mowing, before establishing the working area map, please refer to FIG. 36, a specified RTK base station serial number is input on the application interface by manually inputting it or by scanning the identification code on the RTK base station 1700, thereby ensuring that the same RTK base stations 1700 are used during mapping and actual mowing, which improves the positioning accuracy.

In one embodiment, before establishing the working area map, it is necessary to first establish a working station on the application interface of the intelligent terminal 130 and set a full-permission identification code (referred to as a full-authority PIN, as the first permission identification code) and a partial-permission identification code (referred to as a partial-authority PIN, as the second permission identification code) for the working station.

In one embodiment, the full-permission identification codes and the partial-permission identification codes may be assigned to different operators, so that the different operators have different permission levels. The full-permission identification code and the partial-permission identification code are used to confirm the operator's permission level when the operator uses the working station, so as to open corresponding permissions for the operator according to the operator's permission level.

In one embodiment, the operator with the full-permission identification code may have full permission to control and edit the entire working station and all map areas within the working station. The operator with the partial-permission identification code can only view the working station and the map area within the working station, but cannot edit it. It should be noted that, there may be a plurality of the partial-permission identification codes, and the permissions of each partial-permission identification code may be different.

In one embodiment, the first permission identification code and the control code may be set to be the same or different.

In one embodiment, after the working station is established and the permission identification code is set, the working area map is established. First, the mower is controlled to move along the boundary of the working area, and coordinate information of the mower is recorded in real time to generate a working area boundary map. Second, a no go zones is set within the working area boundary map. Finally, the position of the charging station is set in the working area boundary map to generate the working area map.

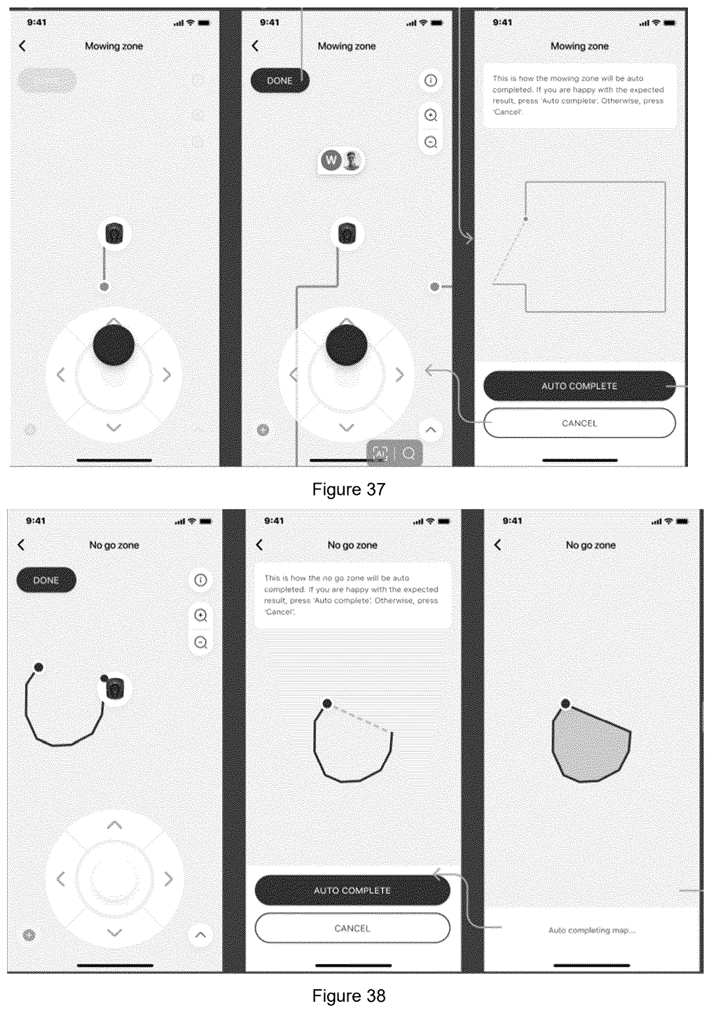

Please refer to FIG. 37. A direction button on the application of the intelligent terminal 130 is provided with four directions: front, back, left, and right. The direction button on the application of the intelligent terminal 130 are used to control the mower to move along the boundary of the working area, and the coordinate information of the mower is recorded in real time. After controlling the mower to move along the boundary in a circle, by clicking a done button on the application interface, a starting point and a final point will be automatically connected together to form a closed-loop working area boundary map. An area within the working area boundary map is a mowable area.

In one embodiment, when controlling the mower to move along the boundary of the working area, a coordinate recording mode may be pre-selected as a pre-selected mode. The pre-selected mode is manual mode, an automatic mode or a combination of the two. The coordinate information of the mower is recorded in real time using the pre-selected mode to generate the working area boundary map.

In one embodiment, in the automatic mode, the mower automatically records the coordinate information of the mower in real time according to a preset time interval or a preset distance to generate the working area boundary map. In the manual mode, the operator needs to manually confirm before the mower will record the current coordinates.

In one embodiment, in the automatic mode, a fixed preset time interval or preset distance may be used, or the preset time interval or preset distance may be adjusted in real time according to a curvature of the boundary wire.

In one embodiment, when the preset time interval or preset distance is adjusted in real time according to the curvature of the boundary wire, the preset interval or preset distance can be increased in a straight line segment of the boundary wire, thereby reducing an amount of data collection, reducing a data processing burden, and not affecting an accuracy of the working area boundary map. In a curved section of the boundary wire, the preset time interval or preset distance may be reduced to increase the amount of data collection, thereby facilitating a generation of an accurate boundary curve.

In one embodiment, when controlling the mower to move along the boundary of the working area, a walking speed of the mower may also be adjusted on the application interface. For example, when the boundary wire is the straight line segment, the walking speed may be increased to speed up a mapping speed. When the boundary wire is the curved segment, the walking speed is reduced, so that the mower can be controlled to walk along the boundary wire more accurately, which enables that the generated boundary curve to be more accurate.

In one embodiment, after the working area boundary map is generated, if there are areas in the working area where the mower cannot walk, such as houses, lakes, and bushes, the no go zone needs to be set within the working area boundary map.

Please refer to FIG. 38. A method of setting the no go zone is similar to generating the working area boundary map. The direction button on the application of the intelligent terminal 130 are also used to control the mower to walk along the no go zone, and the coordinate information of the mower is recorded in real time, so as to complete the setting of the no go zone. The no go zone is a restricted area for the mowers. During subsequent path planning, recharging, and other actions, the mowers are restricted from entering the no go zone. There may be a plurality of no go zones. If there are no no go zones in the working area, operations of setting the no go zone may be omitted.

In an embodiment, after setting the no go zone in the working area boundary map, it is further necessary to set the position of the charging station in the working area boundary map to generate the working area map.

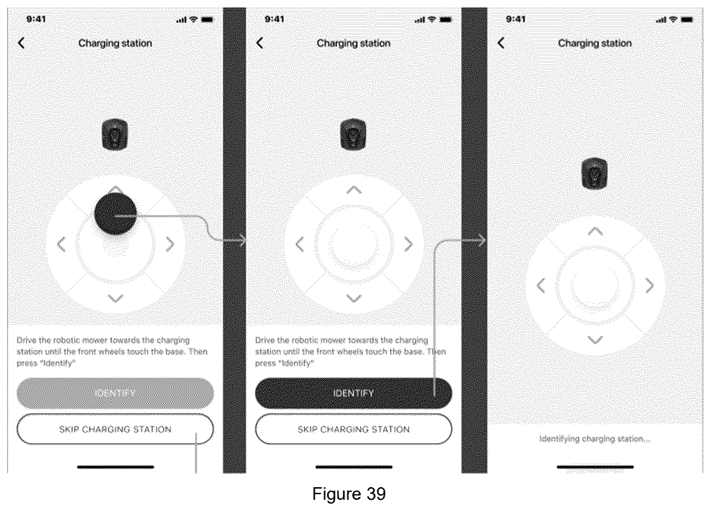

Please refer to FIG. 39. The mower is controlled to reach the charging station by using the direction button on the application of the intelligent terminal 130. When front wheels of the mower hit a bottom plate of the charging station, the identification button (IDENTIFY) on the application interface may be clicked to record the current position of the mower and a previous entry direction of the mower, thereby determining the position of the charging station.

In one embodiment, after generating the working area map, the generated working area map needs to be confirmed. During a confirmation process, the generated working area map may be selected. The operator clicks a confirmation button on the application interface, and the mower automatically moves along the boundary of the working area map. At this time, the operator may then verify whether walking path of the mower is correct. If not, the working area map may be reestablished. If correct, the working area map is confirmed to be correct. The mower may then begin working according to a schedule.

In one embodiment, the working area boundary wire represents an area outside the working area, and in principle, driving out is not allowed. Therefore, after the working area map is generated and confirmed, a prohibited crossing attribute may be set for the boundary wires in the working area map. When the mower exceeds the working area and exceeds a set time period due to its own reasons or external forces, an alarm may be issued and a pre-set command of exceeding the working area may be executed at the same time, such as stopping walking and stopping the cutter.

In one embodiment, after the working area map is generated and confirmed, the boundary wire at the passage in the working area map may also be used. For example, the boundary wire of the passage connecting a front yard and a back yard is set with a passage attribute. When the mower passes through the boundary wire with the passage attribute, the mower needs to turn off the cutter.

In one embodiment, after the map is completed, a mowing function may be started, and the mower will mow according to the generated working area map and the path generated based on the working area map.

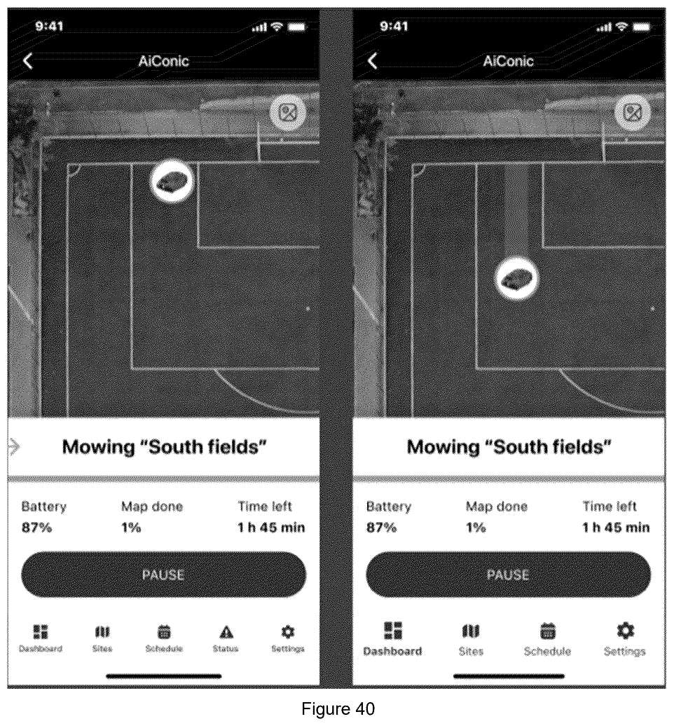

Please refer to FIG. 40. There may be a plurality of maps. A map of the current position of the mower or an area the operator wants the mower to mow is selected, and the mower will work. Please refer to FIG. 40. The application interface of the intelligent terminal 130 will display information such as current work completion progress (Map done), battery current (Battery), and remaining time (Time left) in real time.

FIG. 41 shows a schematic view of an after-sales service system for the garden tool 110 in the management system 100. The after-sales service system in the management system 100 includes the garden tool 110, the cloud server 150 and a client terminal 160.

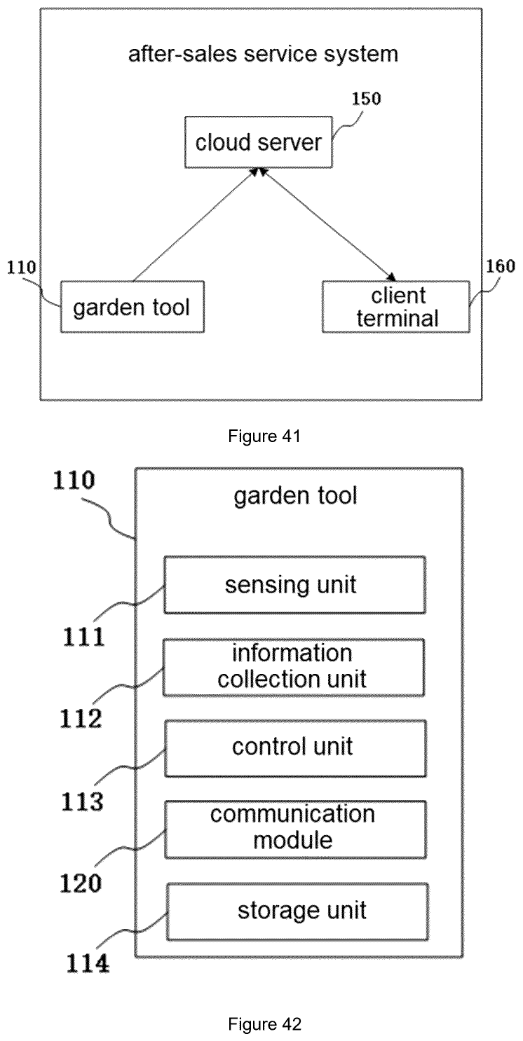

FIG. 42 is a schematic view of the garden tool 110. The garden tool 110 includes a sensing unit 111, an information collection unit 112, a control unit 113, a communication module 120 and a storage unit 114.

In one embodiment, the sensing unit 111 is used to detect the working parameters of the garden tool 110. The working parameters may be operating parameters of the garden tool 110, such as motor current, motor voltage, battery power, motor and battery usage time, motor rotating speed, battery output voltage, output current, output power, current location, GPS positioning, mileage, etc.

In one embodiment, after the garden tool 110 is repaired, information of updated components may be re-entered through the sensing unit 111, and a maintenance record may be generated based on device parameters of the garden tool before and after the maintenance.

In one embodiment, the information collection unit 112 is used to collect the working parameters of the garden tool 110. Different faults of the garden tool 110 will generate different fault codes. The information collection unit 112 may further be used to collect fault information (e.g. the fault codes).

In one embodiment, when the information collection unit 112 collects the working parameters of the garden tool, it may obtain sensing unit data detected by the sensing unit of the garden tool through a port of the sensing unit. The information collection unit 112 may further perform data processing and data conversion on the sensing unit data to obtain the working parameters of the garden tool.

In one embodiment, the port of the sensing unit 111 may be I2C, SPI, UART, or analog input (such as voltage, current) to achieve connection. The information collection unit 112 may collect data by the sensing unit 111 in real time through the port of the sensing unit. The collected data includes reading analog signals, parsing digital signals, or receiving data packets provided by sensing units. Data processing and data conversion on the sensing unit data include unit conversion, filtering, calibration, data formatting and other operations.

In one embodiment, the control unit 113 is configured to send the control instructions to the components in the garden tool 110 and receive detection information returned by the components of the garden tool 110 according to the control instructions. The control instruction is used to control the garden tool 110 to run a program detection component.

In one embodiment, the control unit 113 is triggered to generate the control instructions based on a human-computer interaction, or the control unit 113 automatically generates the control instructions when the components of the garden tool 110 are installed or replaced.

In one embodiment, when the user purchases garden tool 110 and installs or replaces components in the garden tool 110, after installing the components according to installation operations obtained by the client terminal 160 from the cloud server 150, the control instructions may be generated based on the human-computer interaction of the client terminal 160 or a human-computer interaction button of the garden tool 110. The control instructions control the garden tool 110 to run a program to detect whether the components are successfully installed so as to perform normal functions. Alternatively, the assemblies of the garden tool 110 may automatically generate the control instructions to implement a self-checking operation.

In one embodiment, after a spare component of the garden tool is replaced, a standard program is run to check whether the spare component is qualified. For specific assemblies of the mower, such as buttons and sensing units, the human-computer interaction is required. A maintenance person/user is required to press the button according to instructions and lift or push a machine body of the mower to trigger a generation of the control instructions to achieve functional checking. Assemblies such as motherboards and radars may be controlled and detection information may be obtained by automatically generating control instructions through a processor without a need for the operator to interact with the machine.

In one embodiment, the communication module is used to upload working parameters, fault information, and detection information to the cloud server, and both users and manufacturers can obtain the data through the client terminal. Specifically, the users can only obtain relevant parameters of the garden tool they are bound to, while the manufacturers may obtain the relevant parameters of all successfully uploaded garden tool.

In one embodiment, before uploading the working parameters, fault information and detection information to the cloud server, the communication module is further used to: obtain a communication state of the communication module and determine whether the communication state is a connected state. If the communication state is the connected state, the communication module uploads the working parameters, fault information and detection information to the cloud server. If the communication state is a disconnected state, the communication module uploads the working parameters, fault information and detection information to the storage unit.

In one embodiment, when the communication module performs a function of uploading the working parameters, fault information and detection information to the cloud server, it is specifically used to: use the working parameters, fault information and detection information as data to be uploaded, convert the data format of the data to be uploaded, and obtain the data packet. The communication module is connected with the cloud server according to the communication protocol. After the communication module is successfully connected with the cloud server, the data packet is transmitted to the cloud server according to a network transmission.

In one embodiment, the data packet for converting the data format of the uploaded data may be in JSON or XML protocol format. The communication protocol may be HTTP, MQTT, etc. When connecting the communication module with the cloud server, an identity of the communication module may be corrected to verify an upload permission and ensure a security of data in the cloud server. The communication module may transmit data packets to the cloud server through network transmission such as HTTP POST request and TCP/IP socket, etc.

In one embodiment, after receiving the uploaded data packet, the cloud server needs to perform operations such as data parsing, verification, and storage in a database or other data storage system. In addition, the cloud server may further send a confirmation message to the communication module to ensure that the data has been successfully received and processed. Specifically, confirmation may be performed by sending an HTTP response code, replying to an MQTT message, etc.

In one embodiment, after the garden tool is successfully connected with a cloud terminal, various parameter data recorded by the sensing unit during use of the garden tool will be uploaded to the cloud server. If the operator wants to check a product failure of the garden tool, the operator may go to the cloud server through the serial number of the garden tool to obtain the corresponding relevant parameter information.

In one embodiment, the storage unit is used to save the working parameters, fault information, and detection information when a communication of the communication module is blocked.

In one embodiment, the cloud server is further used to: use the working parameters, fault information, and detection information as device data, perform a fault classification and health detection based on the device data to obtain early warning results, divide the device data into multiple dimensions to obtain dimensional data, and generate a product after-sales portrait based on the dimensional data.

In one embodiment, the working parameters are parameters generated during use of the garden tool. As the usage times and duration of use increase, the components in the garden tool will experience varying degrees of wear and tear, functional loss, etc. Therefore, by analyzing the working parameters, the health state of garden tool may be determined.

In one embodiment, when different faults occur in the garden tool, different fault codes are generated to indicate fault conditions of the garden tool. The health state of garden tool may be determined based on the fault conditions thereof. The health state of garden tool may be used to provide different forms of safety early warnings for the garden tool to ensure safeties of the garden tool and corresponding users.

In one embodiment, the cloud server performs functions of fault classification and health detection based on the device data to obtain early warning results, which is specifically used to: perform the health detection based on the working parameters in the device data to obtain health states of the components in the garden tool; classify fault levels based on the health states and fault information in the device data to obtain the fault levels of the components in the garden tool; and provide graded early warnings based on the fault levels.

In one embodiment, the components in the garden tool may have different health states according to different degrees of use. Different health states may be visually displayed in the client terminal through different colors to inform the user whether the components of the garden tool are healthy and whether their functions are normal.

In one embodiment, different health states correspond to different prognostic measures. For the components of the garden tool in a poor health state, there may be irreparable faults that affect a normal use of the garden tool. The different health states may then be categorized into different levels of the fault levels. Furthermore, different fault information may correspond to different fault levels.

In one embodiment, faults of the garden tool may be roughly categorized into three levels. Level 1 fault notifies faults such as reminders for oil changes or blade replacements. Level 2 fault notifies faults such as warnings for full lawn collection boxes or motor overloads, which may be resolved after a restart. Level 3 fault notifies faults such as warnings for motor damage or battery failure, which may require to be repaired.

In one embodiment, the cloud server performs a function of multi-dimensional division of the device data to obtain the dimensional data, which is specifically used to: extract data attributes of the device data and use the data attributes as data dimensions, collect and classify the device data according to the data dimensions to obtain the dimensional data. The data dimensions may include characteristic dimensions, time dimensions, geographic dimensions, and so on.

In one embodiment, the characteristic dimensions refer to dividing product data according to different product characteristics. For example, the garden tool may be divided according to product characteristics such as a type of the garden tool, a corresponding product model, and a corresponding product function.

In one embodiment, the time dimension refers to dividing the product data by time so as to observe sales changes of products in different time periods. The time dimensions may be divided according to the time dimensions such as year, season, and month.

In one embodiment, the geographic dimension refers to dividing the product data by geographic positions to understand product sales and market demand in different regions. The geographic dimension may be divided according to the geographic dimensions such as country, state/province, and city.

In one embodiment, through the multi-dimensional division, changes and relationships of the garden tool in different dimensions may be deeply understood to assist in a subsequent optimization and improvement of the garden tool.

In one embodiment, the cloud server performs a function of generating a product after-sales portrait based on the dimensional data, which is specifically used to: clean the dimensional data to obtain standard data, assign weights to the standard data to obtain weighted data, and construct a portrait based on the data dimensions of the dimensional data and the weighted data to obtain the product after-sales portrait.

In one embodiment, the generated multi-dimensional data is integrated and cleaned to ensure accuracy and consistency of the data. By evaluating and assigning weights to the different dimensional data, important dimensional data may be highlighted.

In one embodiment, the data dimensions of the dimensional data may be used as portrait labels, and summary statistics are performed based on the portrait labels and the weighted data to obtain the product after-sales portrait. Taking an after-sales portrait of the mower as an example, the after-sales portrait includes a product model, sales time, sales region, etc. of the mower, and corresponding weighted data is assigned according to different emphases.

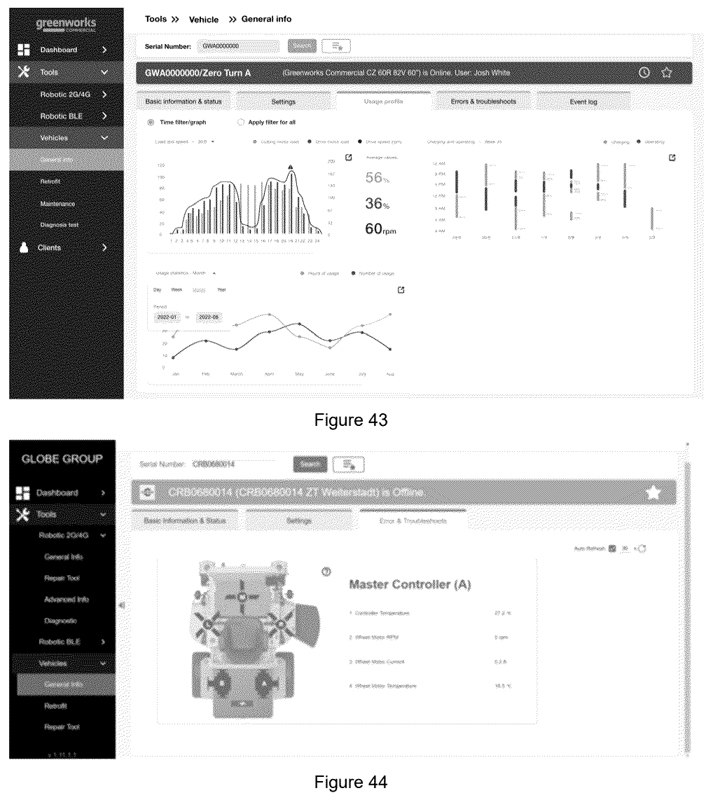

Please refer to FIG. 43. The product after-sales portrait may be visualized through the client terminal. Specifically, charts, graphs, indicators and the like may be used to intuitively display the characteristics of the garden tool in multiple dimensions.

In one embodiment, the product after-sales portrait is dynamic and will be continuously updated and improved as the dimensional data of the garden tool changes to update the dimensional data and regenerate and adjust the product after-sales portrait. By generating the product after-sales portrait, a situation of the garden tool in multiple dimensions may be deeply understood, which helps R&D personnel better identify a target market and consumer groups of the garden tool, and promotes product improvements.

In one embodiment, when the mower in a certain area frequently fails due to mowing motor overload and a walking motor efficiency is always below 30%, then when developing subsequent models, it is necessary to increase a power of the mowing motor and reduce a power of the walking motor. If the mower in a certain place often has insufficient power and long working hours, the relevant client terminal may also recommend a high-power model of this device to the user.

In one embodiment, the client terminal may be used to obtain target data from the cloud server according to a checking instruction and visualize the target data. The client terminal may be the aforementioned intelligent terminal 130.

In one embodiment, the checking instruction may be the serial number or a string number of the garden tool. Based on the serial number, relevant parameter information of the corresponding garden tool may be obtained.

In one embodiment, during the maintenance of garden tool, the checking instruction may be a maintenance instruction for a component of the garden tool that needs to be maintained, and the maintenance operations (i.e., the target data) for the component that needs to be maintained may be obtained through the maintenance instruction. For example, if the component that needs to be maintained is a mower motherboard, the maintenance instruction is determined based on a type and a model of the mower motherboard to obtain corresponding maintenance operations. A maintenance personnel or user may maintain the mower according to the maintenance operations.

In one embodiment, the target data may be visualized through a visualization tool or a library, and the visualization tool includes Matplotlib, D3.js, Tableau, Power BI, and the like.

In one embodiment, after the target data is related parameters of garden tool, the client terminal may display the target data differently according to different permissions, tool attributes, etc.

In one embodiment, the relevant parameters of garden tool may be divided into general information and advanced information. The general information includes device information, control device state, and device configuration information. Real-time assembly information is the advanced information. When the client terminal is the user, a visual display is the general information. When the client terminal is the manufacturer, the visual display is a combination of the general information and the advanced information.

In one embodiment, when the target data is the early warning result obtained during the fault classification and health detection based on the device data, the client terminal may differently display the results obtained by the fault classification and health detection.

Please refer to FIG. 44. FIG. 44 is a UI page display view of a component in electrical work. Wherein, a component A (a main controller), a component B, a component L, a component R, a component M, etc. may be displayed differently according to different health conditions. For the main controller A, parameter information such as controller temperature, wheel rotating speed, wheel motor current, and wheel motor temperature may further be displayed on a page.

In one embodiment, the components in the garden tool may have different health states according to different degrees of use. When a health state of the component indicates a normal use, it may be displayed in green. When the health state of the component indicates that it is nearing a duration life and needs replacement, it may be displayed in yellow. When the health state of the component indicates that it is past the duration life or has an irreversible fault, it may be displayed in red.

In one embodiment, the garden tool may realize functions such as data detection, collection, uploading, and storage, thereby realizing an intelligence of the garden tool and improving efficiency of an Internet of Things of the garden tool. The data is uploaded to the cloud server for processing through the garden tool. Based on a connection between the garden tool and the cloud server, efficient processing of the relevant data of the garden tool is achieved.

In one embodiment, through data transmission between the cloud server and the client terminal, a three-terminal interaction among the garden tool, the cloud server and the client terminal may be realized, which enables timely update and processing of after-sales data of the garden tool, ensures a safety of the user, improves user experience, and provides a support for an after-sales optimization of the garden tool.

In one embodiment, the management system 100 may further include an after-sales management method for the garden tool 110. An execution subject of the management method includes but is not limited to at least one of electronic devices such as a server terminal or a terminal that can be configured to execute the method. In other words, an after-sales service method based on the garden tool may be executed by software or hardware installed on a terminal device or a server terminal.

In one embodiment, a server terminal includes but is not limited to: a single server, a server cluster, the cloud server or a cloud server cluster, etc. The server may be an independent server or the cloud server that provides basic cloud computing services such as cloud services, cloud databases, cloud computing, cloud functions, cloud storage, network services, cloud communications, middleware services, domain name services, security services, content delivery networks (CDNs), and big data and artificial intelligence platforms.

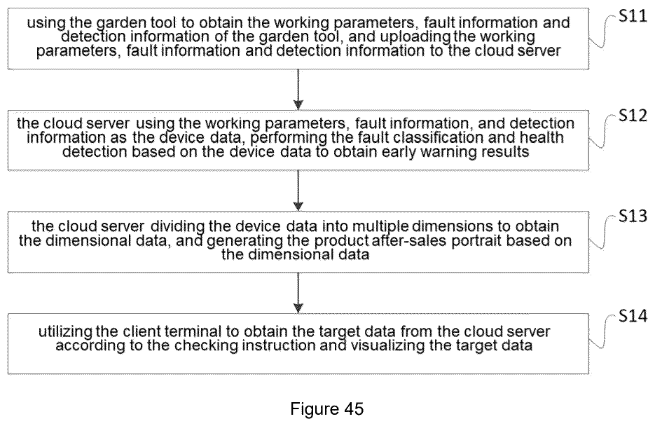

FIG. 45 is a flowchart showing a management method of the garden tool, and the management method may be applied to the above-mentioned management system. When the management method manages the after-sales service of the garden tool 110, the following operations may be included:
S11, using the garden tool to obtain the working parameters, fault information and detection information of the garden tool, uploading the working parameters, fault information and detection information to the cloud server;
S12, the cloud server using the working parameters, fault information, and detection information as the device data, performing the fault classification and health detection based on the device data to obtain early warning results;
S13, the cloud server dividing the device data into multiple dimensions to obtain the dimensional data, and generating the product after-sales portrait based on the dimensional data; and
S14, utilizing the client terminal to obtain the target data from the cloud server according to the checking instruction and visualizing the target data.

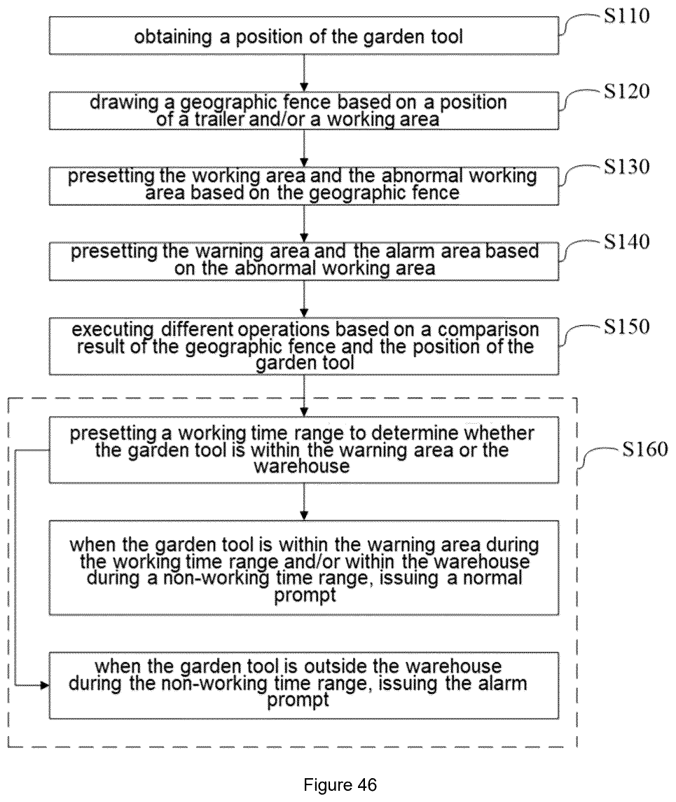

FIG. 46 is a flowchart showing the management method of the garden tool, and the management method may be applied to the above-mentioned management system. When the management method performs the management on the position of the garden tool 110, the following operations may be included:
obtaining a position of the garden tool;
drawing a geographic fence based on a position of a trailer and/or a working area;
presetting the working area and the abnormal working area based on the geographic fence;
presetting the warning area and the alarm area based on the abnormal working area;
executing different operations based on a comparison result of the geographic fence and the position of the garden tool; and
presetting a working time range to determine whether the garden tool is within the warning area or the warehouse, when the garden tool is within the warning area during the working time range and/or within the warehouse during a non-working time range, issuing a normal prompt, and when the garden tool is outside the warehouse during the non-working time range, issuing the alarm prompt.

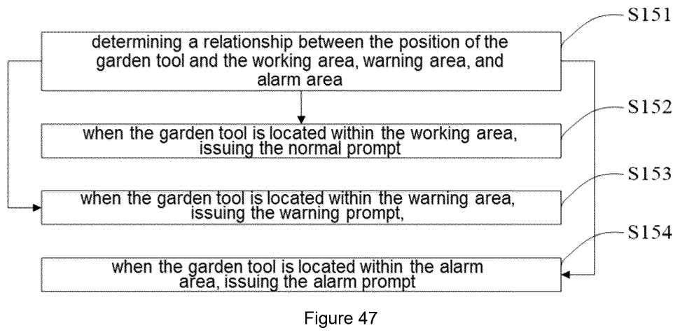

FIG. 47 shows the comparison result of the geographic fence and the position of the garden tool to execute different operations, which includes following operations:
determining a relationship between the position of the garden tool and the working area, warning area, and alarm area;
when the garden tool is located within the working area, issuing the normal prompt;
when the garden tool is located within the warning area, issuing the warning prompt, controlling the corresponding garden tool to emit a warning prompt sound; and
when the garden tool is located within the alarm area, issuing the alarm prompt, controlling the corresponding garden tool to emit an alarm prompt sound, locking the corresponding garden tool, and displaying the position of the corresponding garden tool.

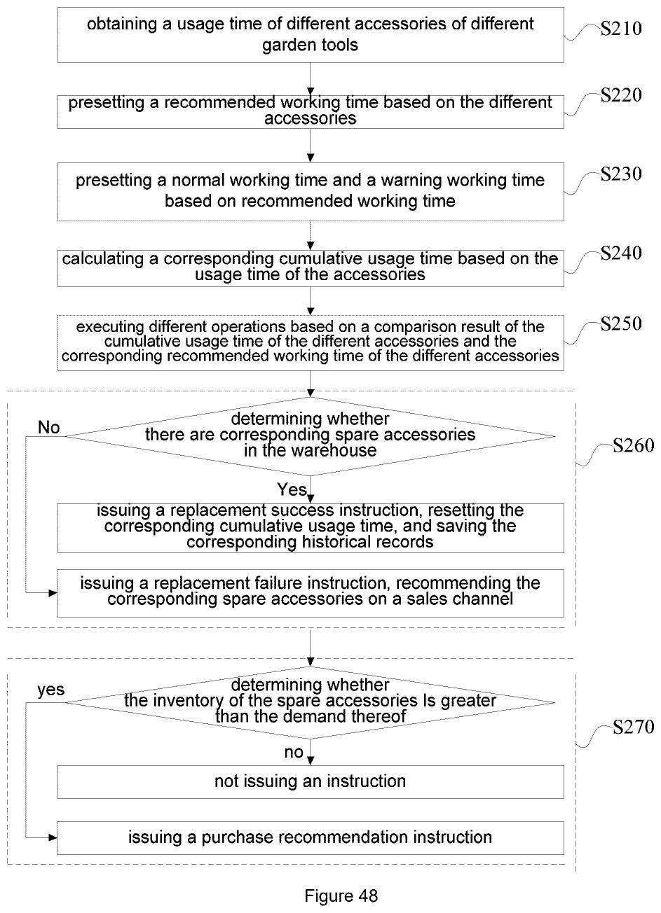

FIG. 48 is another flowchart showing the management method of the garden tool, and the management method may be applied to the above-mentioned management system. When the management method performs the management on the different accessories of the different garden tools 110, the following operations may be included:
obtaining a usage time of different accessories of different garden tools;
presetting a corresponding recommended working time based on the different accessories;
presetting a normal working time and a warning working time based on recommended working time;
calculating a corresponding cumulative usage time based on the usage time of the accessories;
executing different operations based on a comparison result of the cumulative usage time of the different accessories and the corresponding recommended working time of the different accessories;
determining whether there are corresponding spare accessories in the warehouse to execute different instructions, if there are corresponding spare accessories, issuing a replacement success instruction, resetting the corresponding cumulative usage time, saving the corresponding historical records, if there is no corresponding spare accessory, issuing a replacement failure instruction, recommending the corresponding spare accessories on a sales channel; and
executing different operations based on the comparison results of the inventory and demand of various spare parts in the warehouse, when an inventory of spare accessories is greater than or equal to a demand, not issuing an instruction, and when the management terminal determines that the inventory of spare accessories is less than the demand, issuing a purchase recommendation instruction.

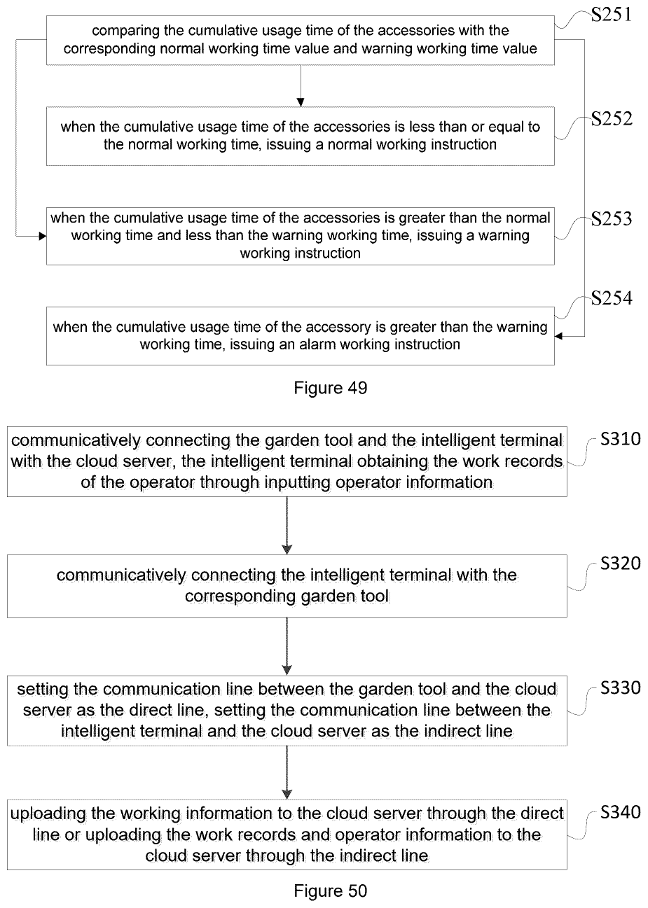

FIG. 49 illustrates in detail a process of executing different operations based on the comparison result of the cumulative usage time of the different accessories and the corresponding recommended working time of the different accessories, which includes following operations:
comparing the cumulative usage time of the accessories with the corresponding normal working time value and warning working time value;
when the cumulative usage time of the accessories is less than or equal to the normal working time, issuing a normal working instruction;
when the cumulative usage time of the accessories is greater than the normal working time and less than the warning working time, issuing a warning working instruction; and
when the cumulative usage time of the accessory is greater than the warning working time, issuing an alarm working instruction.

It may be seen that in the above operations, when the work group needs to be dispatched to complete the work, the position of various types of the garden tool can be known in real time, and then the various garden tool can be effectively managed to prevent a loss of the garden tool. When the garden tool exceeds the working area for a certain period of time, a corresponding alarm signal will be issued, and the garden tool can be self-locked synchronously, thereby realizing the management of the garden tool. At the same time, by monitoring various accessories in the various types of the garden tool and comparing the cumulative usage time of the accessories with the corresponding recommended working time, the accessories can be replaced in a timely manner, thereby improving work efficiency to a certain extent. By determining whether there are corresponding spare accessories in the warehouse, the work efficiency can be further improved.

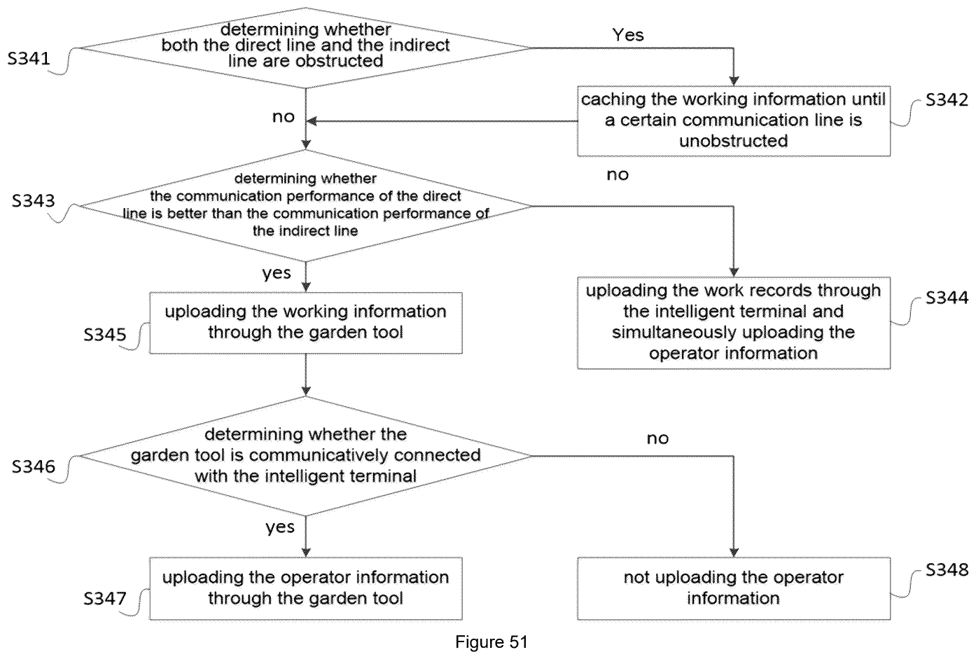

FIG. 50 is another flowchart showing the management method of the garden tool, and the management method may be applied to the above-mentioned management system. When the management method performs the management on a working situation of the garden tool 110, the following operations may be included:
communicatively connecting the garden tool and the intelligent terminal with the cloud server, the intelligent terminal obtaining the work records of the operator through inputting operator information;
communicatively connecting the intelligent terminal with the corresponding garden tool;
setting the communication line between the garden tool and the cloud server as the direct line, setting the communication line between the intelligent terminal and the cloud server as the indirect line; and
uploading the working information to the cloud server through the direct line or uploading the work records and operator information to the cloud server through the indirect line.

FIG. 51 illustrates in detail the process of uploading the working information to the cloud server through the direct line or uploading the work records and operator information to the cloud server through the indirect line, which includes following operations:
determining whether both the direct line and the indirect line are obstructed;
if the direct line and the indirect line are obstructed at the same time, caching the working information until a certain communication line is unobstructed;
if the direct line or the indirect line is unobstructed, determining whether the communication performance of the direct line is better than the communication performance of the indirect line;
if the communication performance of the direct line is weaker than the communication performance of the indirect line, uploading the work records through the intelligent terminal and simultaneously uploading the operator information;
if the communication performance of the direct line is stronger than the communication performance of the indirect line, uploading the working information through the garden tool;
determining whether the garden tool is communicatively connected with the intelligent terminal;
if the garden tool is communicatively connected with the intelligent terminal, uploading the operator information through the garden tool; and
if the garden tool is not communicatively connected with the intelligent terminal, not uploading the operator information.

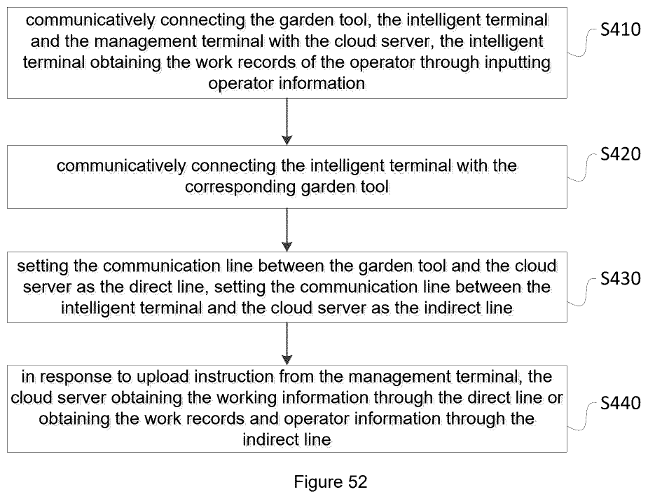

FIG. 52 is another flowchart showing the management method of the garden tool, and the management method may be applied to the above-mentioned management system. When the management method performs the management on the working situation of the garden tool 110, the following operations may be included:
communicatively connecting the garden tool, the intelligent terminal and the management terminal with the cloud server, the intelligent terminal obtaining the work records of the operator through inputting operator information;
communicatively connecting the intelligent terminal with the corresponding garden tool;
setting the communication line between the garden tool and the cloud server as the direct line, setting the communication line between the intelligent terminal and the cloud server as the indirect line; and
in response to upload instruction from the management terminal, the cloud server obtaining the working information through the direct line or obtaining the work records and operator information through the indirect line.

It may be seen that, in the above method, when the work group needs to be dispatched to complete work, the various types of the garden tools may be monitored in real time to obtain corresponding positions, the working information, etc. The operator may also select an appropriate communication line to upload data through the intelligent terminal. The intelligent terminals may not only serve as a data transfer station, but also as an auxiliary tool for the operator to improve work efficiency. At the same time, the operator's physical health status may also be monitored in real time through the intelligent terminal to ensure operator's safety.

The embodiments disclosed above are intended only to illustrate the disclosure. These embodiments do not describe all the details in detail, nor do they limit the disclosure to the specific embodiments described. Obviously, many modifications and variations are possible based on the content of this specification. These embodiments are selected and described in detail to better explain the principles and practical applications of the disclosure, thereby enabling those skilled in the art to better understand and utilize the disclosure. This disclosure is limited only by the claims and their full scope and equivalents.

What is claimed is:

1. A management system of a garden tool, comprising:
a cloud server;
at least one garden tool, the at least one garden tool provided with a communication module, and working information of the at least one garden tool being uploaded to the cloud server through the communication module; and
at least one intelligent terminal, the at least one intelligent terminal communicatively connected with the at least one garden tool to receive the working information of the at least one garden tool, and communicatively connected with the cloud server to obtain work records of an operator through inputting operator information of the operator;
wherein, the at least one garden tool is configured to upload the working information to the cloud server or upload the work records and the operator information to the cloud server through the at least one intelligent terminal according to a communication protocol.

2. The management system of the garden tool according to claim 1, wherein, the at least one garden tool is configured to upload the working information to the cloud server through a direct line according to the communication protocol, and the at least one garden tool is configured to upload the work records and the operator information to the cloud server through the at least one intelligent terminal through an indirect line according to the communication protocol.

3. The management system of the garden tool according to claim 2, wherein, when a communication performance of the direct line is stronger than a communication performance of the indirect line, an executed action of the management system is to upload the working information through the at least one garden tool, and when the communication performance of the direct line is weaker than the communication performance of the indirect line, the executed action is to upload the work records through the at least one intelligent terminal and simultaneously upload the operator information.

4. The management system of the garden tool according to claim 3, wherein, a comparison of the communication performance of the communication protocol comprises one or more of bit error rate, signal-to-noise ratio, bandwidth, data rate, delay and throughput.

5. The management system of the garden tool according to claim 2, wherein, when the direct line and the indirect line are obstructed, the executed action is that the at least one garden tool or the at least one intelligent terminal caches the working information until one of the direct line and the indirect line is unobstructed.

6. The management system of the garden tool according to claim 1, further comprising a trailer, wherein, a gateway is provided on the trailer, the gateway is configured to communicate with the at least one garden tool, the at least one intelligent terminal, and the cloud server respectively to upload the working information and the operator information through the gateway.

7. The management system of the garden tool according to claim 1, wherein, the communication module of the at least one garden tool is one or more of 4G, 5G, Wifi, Lora, Zigbee, Bluetooth, and a Bluetooth module, and the Bluetooth module is a Bluetooth device or a Bluetooth battery pack.

8. The management system of the garden tool according to claim 7, wherein, the at least one intelligent terminal is paired with the Bluetooth device through at least one of scanning a QR code located on the Bluetooth device, contacting an NFC, or inputting a PIN code, the Bluetooth battery pack is configured to supply power to the at least one garden tool, and the Bluetooth battery pack is configured to obtain the working information of the at least one garden tool and transmit the working information to the at least one intelligent terminal through Bluetooth.

9. The management system of the garden tool according to claim 1, wherein, the at least one intelligent terminal is provided with an intelligent terminal positioning module to obtain positioning information of the at least one intelligent terminal, the at least one intelligent terminal is further provided with a user interaction interface, the user interaction interface is configured to receive and execute user instructions and display the working information of the at least one garden tool, and the at least one intelligent terminal is configured to obtain corresponding working tasks according to the user instructions and pair with the corresponding garden tool according to the working tasks.

10. The management system of the garden tool according to claim 1, wherein, the at least one intelligent terminal is configured to at least display the operator's physical health status, information of bound garden tool, current working hours and historical work records, and when the at least one intelligent terminal determines that the operator's physical health status is not within preset conditions, the executed action is that the at least one intelligent terminal obtains the operator's positioning information to send an alarm message to the cloud server, and send the alarm message to other intelligent terminals based on the positioning information.

11. The management system of the garden tool according to claim 1, wherein, the at least one garden tool is provided with a garden tool positioning module to position the at least one garden tool, the management system further comprises at least one management terminal, and the at least one management terminal is used to obtain information of the at least one garden tool and draw a geographic fence based on a position of a trailer and/or a working area.

12. The management system of the garden tool according to claim 11, wherein, the at least one management terminal is configured to preset the working area and an abnormal working area based on the geographic fence, when the at least one management terminal determines that a position of the at least one garden tool is within the working area, the executed action is that the at least one management terminal issues a normal prompt, and when the at least one management terminal determines that the position of the at least one garden tool is within the abnormal working area, the executed action is that the at least one management terminal issues a warning prompt or an alarm prompt.

13. The management system of the garden tool according to claim 12, wherein, the at least one management terminal is configured to preset a warning area and an alarm area based on the abnormal working area, when the at least one management terminal determines that the position of the at least one garden tool is within the warning area, the executed action is that the at least one management terminal issues the warning prompt, and when the at least one management terminal determines that the position of the at least one garden tool is within the alarm area, the executed action is that the at least one management terminal issues the alarm prompt.

14. The management system of the garden tool according to claim 11, wherein, when the at least one management terminal determines that a garden tool taken out from a warehouse and a garden tool stored back to the warehouse are different, the executed action is that the at least one management terminal issues a locking instruction to a lost garden tool to lock the lost garden tool.

15. The management system of the garden tool according to claim 11, wherein, the at least one management terminal is configured to preset a corresponding recommended working time period of each of different accessories of different garden tools, obtain an usage time period of each of the accessories, calculate a corresponding cumulative usage time period based on the usage time period of each of the accessories, and perform different operations based on a comparison result of the cumulative usage time period and the corresponding recommended working time period of each of the accessories.

16. The management system of the garden tool according to claim 15, wherein, the at least one management terminal is configured to preset a normal working time period based on the recommended working time period of each of the accessories, when the at least one management terminal determines that the corresponding cumulative usage time period of one of the accessories is less than or equal to the normal working time period, the executed action is that the at least one management terminal issues a normal working instruction to the one of the accessories, and when the at least one management terminal determines that the corresponding cumulative usage time period of the one of the accessories is greater than the corresponding normal working time period, the executed action is that the at least one management terminal issues a warning working instruction or an alarm working instruction to the one of the accessories.

17. The management system of the garden tool according to claim 16, wherein, the at least one management terminal is further configured to preset a warning working time period based on the recommended working time period of each of the accessories, when the at least one management terminal determines that the cumulative usage time period of the one of the accessories is greater than the corresponding normal working time period and less than the corresponding warning working time, the executed action is that the at least one management terminal issues the warning working instruction to the one of the accessories, and when the at least one management terminal determines that the cumulative usage time period of the one of the accessories is greater than the warning working time period, the executed action is that the at least one management terminal issues the alarm working instruction to the one of the accessories and displays specific information of the corresponding one of accessories on the at least one management terminal.

18. The management system of the garden tool according to claim 16, wherein, when the at least one management terminal determines that there is a corresponding spare part, the executed action is that the at least one management terminal issues a replacement success instruction, resets the corresponding cumulative usage time period, and saves a corresponding historical record, and when the at least one management terminal determines that there is no corresponding spare part, the executed action is that the at least one management terminal issues a replacement failure instruction and recommend corresponding spare parts on a sales market.

19. A management method of a garden tool, comprising:
communicatively connecting the garden tool and an intelligent terminal with a cloud server respectively, and the intelligent terminal obtaining work records of an operator through inputting operator information of the operator;
communicatively connecting the intelligent terminal with the corresponding garden tool;
setting a communication line between the garden tool and the cloud server as a direct line, and setting the communication line between the intelligent terminal and the cloud server as an indirect line; and
uploading working information to the cloud server through the direct line or uploading the work records and the operator information to the cloud server through the indirect line.

20. A management method of a garden tool, comprising:
communicatively connecting the garden tool, an intelligent terminal and a management terminal with a cloud server respectively, and the intelligent terminal obtaining work records of an operator through inputting operator information of the operator;
communicatively connecting the intelligent terminal with the corresponding garden tool;
setting a communication line between the garden tool and the cloud server as a direct line, and setting a communication line between the intelligent terminal and the cloud server as an indirect line; and
in response to upload instruction from the management terminal, the cloud server obtaining the working information through the direct line or obtaining the work records and the operator information through the indirect line.
